(19) United States
(12) Patent Application Publication
(10) Pub. No.: US 2026/0229969 A1
(43) Pub. Date: Aug. 6, 2026

(54) LAMINATED BODY MANUFACTURING APPARATUS AND LAMINATED BODY MANUFACTURING METHOD

(71) Applicant: NHK SPRING CO., LTD., Yokohama-shi, Kanagawa (JP)

(72) Inventor: Michinobu HIRAMA, Yokohama-shi, Kanagawa (JP)

(21) Appl. No.: 19/149,790

(22) PCT Filed: Jan. 23, 2024
(86) PCT No.: PCT/JP2024/001821

§ 371 Date: Jul. 21, 2025

(30) Foreign Application Priority Data
Jan. 23, 2023 (JP) 2023-007929

(51) Int. Cl. H02K 15/0273

(52) U.S. Cl. CPC H02K 15/0273

(57) ABSTRACT

A laminated body manufacturing apparatus includes: a squeeze capable of conveying in a downward direction a plurality of iron core members including latching iron core members and non-latching iron core members; a supply mechanism capable of supplying the iron core members to the squeeze; a conveyor capable of receiving the iron core members supplied from a conveyance direction downstream end portion of the squeeze; and a positioning mechanism capable of moving in a direction toward and a direction away from side surfaces of the iron core members supplied from the conveyance direction downstream end portion of the squeeze in order to position the iron core members supplied onto the conveyor, wherein the squeeze includes a squeeze upstream portion that laterally supports a plurality of the latching iron core members and the non-latching iron core members passing through the squeeze and a squeeze downstream portion that laterally supports latching pieces.

### TECHNICAL FIELD

This disclosure relates to laminated body manufacturing apparatus and laminated body manufacturing method.

### BACKGROUND ART

Laminates in which a plurality of iron core members are laminated have conventionally been manufactured to obtain motor cores (rotor cores or stator cores) that are used in motors installed in electric vehicles and the like.

JP-A No. 2019-118169 describes using a plate laminating apparatus to manufacture a laminate configuring a stator core. In this plate laminating apparatus, a sensor that detects the passage of plates conveyed out from a cylinder serving as a conveyance path and a separation mechanism that supports the plates are provided near the cylinder outlet. Additionally, based on the detection results of the sensor, the separation mechanism is projected onto the plate conveyance path at an optional timing to stop the conveyance of the plates, thereby controlling the supply number and the supply timing of the plates supplied to a jig.

### SUMMARY OF INVENTION

### Technical Problem

If the timing of the projection of the separation mechanism is decided based only on the detection results of the sensor that detects the passage of the plates conveyed out from the cylinder as in the plate laminating apparatus of JP-A No. 2019-118169, the amount of time from when the passage of the plates is detected until the operation of the separation mechanism is completed becomes extremely short when the speed at which the plates are conveyed out from the cylinder is relatively fast. Consequently, the actuator and sensor of the separation mechanism as well as the device for controlling these need to have a fast response speed, and the difficulty of controlling them also increases. Furthermore, if the operating speed of the separation mechanism is reduced by, for example, deterioration of the actuator of the separation mechanism over time, the problem can arise that plates that should stop being conveyed arrive before the operation of the separation mechanism is completed, and the conveyance of those plates cannot be stopped. Moreover, in order to precisely operate the separation mechanism, the need arises to frequently check for deterioration of the actuator of the separation mechanism over time, which increases the frequency of maintenance.

In addition, the plate laminating apparatus of JP-A No. 2019-118169 employs a structure where a jig receives the plates conveyed out from the cylinder, and such jigs typically have different shapes to match the shapes of the plates that are conveyed out. Furthermore, when the user wants to continuously manufacture identical laminates, it is preferred to prepare in advance multiple jigs with identical shapes in order to smoothly perform jig replacement work and the like. Consequently, when using the plate laminating apparatus of JP-A No. 2019-118169 to manufacture a variety of laminates, the need can arise to prepare in advance multiple types of jigs with different shapes.

The present disclosure provides laminated body manufacturing apparatus and laminated body manufacturing method that are capable of accurately and efficiently carrying out laminating of iron core members without requiring special devices or multiple jigs.

### Solution to Problem

A laminated body manufacturing apparatus pertaining to a first aspect of the disclosure comprises: a squeeze capable of conveying in a downward direction a plurality of iron core members including latching iron core members that have latching pieces in a plurality of places on their outer peripheral surfaces and non-latching iron core members that do not have the latching pieces; a supply mechanism that is positioned upstream of the squeeze in a conveyance direction of the iron core members and is capable of selectively supplying the latching iron core members and the non-latching iron core members to the squeeze; a conveyor that can receive the iron core members supplied from the conveyance direction downstream end portion of the squeeze and is capable of conveying the iron core members in a direction intersecting the conveyance direction; and a positioning mechanism that is disposed between the conveyance direction downstream end portion of the squeeze and the conveyor in order to position the iron core members supplied onto the conveyor and is movable in a direction toward and a direction away from side surfaces of the iron core members supplied from the conveyance direction downstream end portion of the squeeze, wherein the squeeze includes a squeeze upstream portion that is positioned on the conveyance direction upstream side of the squeeze and laterally supports a plurality of the latching iron core members and the non-latching iron core members passing through the squeeze and a squeeze downstream portion that is positioned on the conveyance direction downstream side of the squeeze and laterally supports the latching pieces of the latching iron core members passing through the squeeze.

In the above laminated body manufacturing apparatus, the supply timing and the supply number of the iron core members supplied to the conveyor can be simply adjusted by passing the iron core members through the squeeze, so laminates can be continuously manufactured without stopping the apparatus, thus improving manufacturing efficiency. Furthermore, the conveyor can receive, and convey to a predetermined location, the iron core members conveyed out from the squeeze, so it is not necessary to prepare multiple jigs as has conventionally been the case. Moreover, the laminating of the iron core members can be accurately performed by using the positioning mechanism.

A laminated body manufacturing apparatus pertaining to a second aspect of the disclosure is the laminated body manufacturing apparatus pertaining to the first aspect of the disclosure, wherein the positioning mechanism includes a plurality of positioning pieces disposed on the outer periphery of the iron core members placed on the conveyor, and the plurality of positioning pieces include abutment surfaces, which oppose the side surfaces of the iron core members placed on the conveyor, and are movable between a positioning cancellation position where the abutment surfaces are away from the side surfaces of the iron core members placed on the conveyor and a positioning position where the abutment surfaces abut against the side surfaces of the iron core members placed on the conveyor or where the abutment surfaces oppose the side surfaces of the iron core members via a smaller gap than they do in the positioning cancellation position.

In the above laminated body manufacturing apparatus, positioning of the iron core members can be realized without hindering the conveyance of the laminated body.

A laminated body manufacturing apparatus pertaining to a third aspect of the disclosure is the laminated body manufacturing apparatus pertaining to the second aspect of the disclosure, wherein the abutment surfaces include tapered surfaces which, moving downstream in the conveyance direction, come nearer to the side surfaces of the iron core members placed on the conveyor.

In the above laminated body manufacturing apparatus, the iron core members conveyed out from the squeeze can be reliably guided to a predetermined position.

A laminated body manufacturing apparatus pertaining to a fourth aspect of the disclosure is the laminated body manufacturing apparatus pertaining to the second or third aspect of the disclosure, wherein end portions of the abutment surfaces positioned downstream in the conveyance direction are positioned lower than the position of an upper surface of the iron core member that has been directly placed on the conveyor.

In the above laminated body manufacturing apparatus, the iron core member directly placed on the upper surface of the conveyor can be reliably positioned.

A laminated body manufacturing apparatus pertaining to a fifth aspect of the disclosure is the laminated body manufacturing apparatus pertaining to any of the first to fourth aspects of the disclosure, further comprising a holding unit that is disposed between the conveyance direction downstream end portion of the squeeze and the conveyor and is capable of holding the iron core members supplied onto the conveyor before they are placed on the conveyor.

In the above laminated body manufacturing apparatus, the supply of the iron core members to the conveyor can be temporarily stopped.

A laminated body manufacturing apparatus pertaining to a sixth aspect of the disclosure is the laminated body manufacturing apparatus pertaining to the fifth aspect of the disclosure, wherein the positioning mechanism includes a plurality of positioning pieces disposed on the outer periphery of the iron core members placed on the conveyor, and the holding unit is configured by parts of the plurality of positioning pieces, and the plurality of positioning pieces are movable to a holding position where holding surfaces provided on the conveyance direction upstream sides thereof are capable of holding the iron core members supplied from the conveyance direction downstream end portion of the squeeze.

In the above laminated body manufacturing apparatus, temporary holding of the iron core members can be realized without increasing the number of parts of the manufacturing apparatus.

A laminated body manufacturing apparatus pertaining to a seventh aspect of the disclosure is the laminated body manufacturing apparatus pertaining to any of the first to sixth aspects of the disclosure, wherein at least some of the iron core members are configured by a block body in which a plurality of plate-shaped core pieces are joined to each other.

In the above laminated body manufacturing apparatus, a variety of iron core members can be used to manufacture a laminated body.

A laminated body manufacturing apparatus pertaining to an eighth aspect of the disclosure is the laminated body manufacturing apparatus pertaining to the seventh aspect of the disclosure, wherein crimped portions provided in the core pieces configuring the block body are used to join together the core pieces.

In the above laminated body manufacturing apparatus, the core pieces can be simply joined together by laminating and pressing the core pieces in which the crimped portions are formed.

A laminated body manufacturing apparatus pertaining to a ninth aspect of the disclosure is the laminated body manufacturing apparatus pertaining to any of the first to eighth aspects of the disclosure, wherein a plurality of the iron core members are laminated to configure a block core, and the block core configures a motor core on its own or as a result of more than one being laminated and is configured by one or a plurality of the latching iron core members positioned on the conveyance direction downstream side and one or a plurality of the non-latching iron core members positioned on the conveyance direction upstream side.

In the above laminated body manufacturing apparatus, by using the latching iron core members for the iron core members that are downstream among the plurality of iron core members configuring the block core, the timing of the outbound conveyance from the squeeze can be adjusted in block core units.

A laminated body manufacturing apparatus pertaining to a tenth aspect of the disclosure comprises: a supply mechanism capable of supplying, along a predetermined conveyance direction, a plurality of iron core members including latching iron core members that have latching pieces in a plurality of places on their outer peripheral surfaces or inner peripheral surfaces and non-latching iron core members that do not have the latching pieces; a squeeze that is disposed downstream of the supply mechanism in the conveyance direction and is capable of conveying along the conveyance direction, while laterally supporting, the iron core members supplied from the supply mechanism; a conveyor that can receive the iron core members supplied from the conveyance direction downstream end portion of the squeeze and is capable of conveying the iron core members in a direction intersecting the conveyance direction; a separation mechanism that is disposed between the squeeze and the conveyor in the conveyance direction and controls the supply of the iron core members to the conveyor; and a positioning mechanism that is disposed between the separation mechanism and the conveyor in the conveyance direction in order to position the iron core members supplied onto the conveyor and is movable in a direction toward and a direction away from side surfaces of the iron core members supplied from the conveyance direction downstream end portion of the squeeze, wherein the separation mechanism includes latching portions capable of moving between a latching position where they latch a plurality of the latching pieces of the latching iron core members supplied from the conveyance direction downstream end portion of the squeeze and a non-latching position where they do not latch the latching pieces and an actuation device that moves the latching portions to the latching position and the non-latching position.

In the above laminated body manufacturing apparatus, the separation mechanism latches the latching pieces of the latching iron core members, so periods when the non-latching iron core members are passing the position where the separation mechanism is provided can be utilized as periods for the latching portions of the separation mechanism to move to the latching position. Consequently, the support of the iron core members by the separation mechanism can be reliably performed, and the laminating of the iron core members can be accurately implemented.

Furthermore, the conveyor can receive, and convey to a predetermined location, the iron core members conveyed out from the squeeze, so it is not necessary to prepare multiple jigs as has conventionally been the case. Moreover, the laminating of the iron core members can be accurately performed by using the positioning mechanism.

A laminated body manufacturing apparatus pertaining to an eleventh aspect of the disclosure is the laminated body manufacturing apparatus pertaining to the tenth aspect of the disclosure, wherein the actuation device moves the latching portions from the latching position to the non-latching position and thereafter returns them to the latching position during periods when the non-latching iron core members are passing a position on a conveyance path of the iron core members that includes the latching position.

In the above laminated body manufacturing apparatus, the separation mechanism can perform a return operation to return to the latching position where it latches the plurality of iron core members configuring the next block core during the periods when the non-latching iron core members are passing the position where the separation mechanism is provided. Consequently, compared to conventional apparatus, a longer amount of the time for performing this return operation can be ensured.

A laminated body manufacturing method pertaining to a twelfth aspect of the disclosure comprises: a step of supplying, to a squeeze, a plurality of iron core members including latching iron core members that have latching pieces in a plurality of places on their outer peripheral surfaces and non-latching iron core members that do not have the latching pieces, the squeeze including a squeeze upstream portion that is positioned on an upstream side of the squeeze in a conveyance direction of the iron core members and laterally supports a plurality of the latching iron core members and the non-latching iron core members passing through the squeeze and a squeeze downstream portion that is positioned on the conveyance direction downstream side of the squeeze and laterally supports the latching pieces of the latching iron core members passing through the squeeze; a step of moving, to a positioning position, a positioning mechanism disposed between the conveyance direction downstream end portion of the squeeze and the conveyor in order to position the iron core members supplied from the conveyance direction downstream end portion of the squeeze onto the conveyor; a step of supplying the iron core members from the conveyance direction downstream end portion of the squeeze onto the conveyor; and when a predetermined number of the iron core members have been placed on the conveyor, a step of moving the positioning mechanism to a positioning cancellation position and operating the conveyor to convey, in a direction intersecting the conveyance direction, the predetermined number of the iron core members that have been placed on the conveyor.

In the above laminated body manufacturing method, the supply timing and the supply number of the iron core members supplied to the conveyor can be simply adjusted by passing the iron core members through the squeeze, so laminated body can be continuously manufactured without stopping the apparatus, thus improving manufacturing efficiency. Furthermore, the conveyor can receive, and convey to a predetermined location, the iron core members conveyed out from the squeeze, so it is not necessary to prepare multiple jigs as has conventionally been the case. Moreover, the laminating of the iron core members can be accurately performed by using the positioning mechanism.

A laminated body manufacturing method pertaining to a thirteenth aspect of the disclosure is the laminated body manufacturing method pertaining to the twelfth aspect of the disclosure, wherein at least some of the iron core members are configured by a block body in which a plurality of plate-shaped core pieces are joined to each other.

In the above laminated body manufacturing method, a variety of iron core members can be used to manufacture a laminated body.

A laminated body manufacturing method pertaining to a fourteenth aspect of the disclosure is the laminated body manufacturing method pertaining to the twelfth or thirteenth aspect of the disclosure, further comprising a step of moving the positioning mechanism to a holding position where holding surfaces provided on the conveyance direction upstream side thereof are capable of holding the iron core members supplied from the conveyance direction downstream end portion of the squeeze.

In the above laminated body manufacturing method, the supply of the iron core members to the conveyor can be temporarily stopped.

A laminated body manufacturing method pertaining to a fifteenth aspect of the disclosure comprises: a step of supplying, from a supply mechanism, a plurality of iron core members including latching iron core members that have latching pieces in a plurality of places on their outer peripheral surfaces or inner peripheral surfaces and non-latching iron core members that do not have the latching pieces; a step of using a squeeze to convey, while laterally supporting, the iron core members supplied from the supply mechanism, the squeeze being disposed downstream of the supply mechanism in a conveyance direction of the iron core members, and the iron core members laterally supported by the squeeze being conveyable along the conveyance direction through the squeeze; a step of using a separation mechanism to selectively support the iron core members supplied from the conveyance direction downstream end portion of the squeeze, the separation mechanism including latching portions capable of moving between a latching position where they latch a plurality of the latching pieces of the latching iron core members supplied from the conveyance direction downstream end portion of the squeeze and a non-latching position where they do not latch the latching pieces and an actuation device that moves the latching portions to the latching position and the non-latching position, the iron core members being supported as a result of the latching portions positioned in the latching position latching the latching pieces of the latching iron core members; a step of moving, to a positioning position, a positioning mechanism disposed between the separation mechanism and the conveyor in the conveyance direction in order to position the iron core members supplied onto the conveyor; a step of moving the latching portions from the latching position to the non-latching position in order to supply onto the conveyor a plurality of the iron core members supported by the separation mechanism; a step of returning the latching portions that were moved to the non-latching position to the latching position during periods when the non-latching iron core members are passing a position including the latching position on a conveyance path of the iron core members; and when a predetermined number of the iron core members have been placed on the conveyor, a step of moving the positioning mechanism to a positioning cancellation position and operating the conveyor to convey, in a direction intersecting the conveyance direction, the predetermined number of the iron core members that have been placed on the conveyor.

In the above laminated body manufacturing method, the separation mechanism latches the latching pieces of the latching iron core members, so periods when the non-latching iron core members are passing the position where the separation mechanism is provided can be utilized as periods for the latching portions of the separation mechanism to move to the latching position. Consequently, the support of the iron core members by the separation mechanism can be reliably performed, and the laminating of the iron core members can be accurately implemented. Furthermore, the conveyor can receive, and convey to a predetermined location, the iron core members conveyed out from the squeeze, so it is not necessary to prepare multiple jigs as has conventionally been the case. Moreover, the laminating of the iron core members can be accurately performed by using the positioning mechanism.

### Advantageous Effects of Invention

According to the laminated body manufacturing apparatus and the laminated body manufacturing method of this disclosure, it becomes possible to accurately and efficiently carry out laminating of iron core members without requiring special devices or multiple jigs.

### BRIEF DESCRIPTION OF DRAWINGS

FIG. 1 is a plan view showing an example of a latching iron core member supplied to a laminated body manufacturing apparatus pertaining to a first embodiment of the disclosure.

FIG. 2 is a plan view showing an example of a non-latching iron core member supplied to the laminated body manufacturing apparatus pertaining to the first embodiment of the disclosure.

FIG. 3 is a schematic explanatory drawing showing an example of the laminated body manufacturing apparatus pertaining to the first embodiment of the disclosure.

FIG. 4 is a schematic sectional view taken along line D-D of FIG. 3.

FIG. 5 is a schematic sectional view taken along line E-E of FIG. 3.

FIG. 6A is a schematic structural drawing viewed from the position indicated by line F-F of FIG. 3.

FIG. 6B is a schematic structural drawing viewed from the position indicated by line F-F of FIG. 3.

FIG. 7 is a flowchart showing an example of a laminated body manufacturing method pertaining to the first embodiment of the disclosure.

FIG. 8A is an operational explanatory drawing showing main parts of the manufacturing apparatus shown in FIG. 3 when the laminated body manufacturing method shown in FIG. 7 is executed.

FIG. 8B is an operational explanatory drawing showing main parts of the manufacturing apparatus shown in FIG. 3 when the laminated body manufacturing method shown in FIG. 7 is executed.

FIG. 8C is an operational explanatory drawing showing main parts of the manufacturing apparatus shown in FIG. 3 when the laminated body manufacturing method shown in FIG. 7 is executed.

FIG. 9A is an operational explanatory drawing showing the state of a conveyor and a positioning mechanism of the manufacturing apparatus shown in FIG. 3 in the operating state shown in FIG. 8A.

FIG. 9B is an operational explanatory drawing showing the state of the conveyor and the positioning mechanism of the manufacturing apparatus shown in FIG. 3 in the operating state shown in FIG. 8B.

FIG. 9C is an operational explanatory drawing showing the state of the conveyor and the positioning mechanism of the manufacturing apparatus shown in FIG. 3 in the operating state shown in FIG. 8C.

FIG. 10 is a schematic explanatory drawing showing an example of a laminated body manufacturing apparatus pertaining to a second embodiment of the disclosure.

FIG. 11 is a schematic sectional view taken along line G-G of FIG. 10.

FIG. 12 is a flowchart showing an example of a laminated body manufacturing method pertaining to the second embodiment of the disclosure.

FIG. 13A is an operational explanatory drawing showing main parts of the manufacturing apparatus shown in FIG. 10 when the laminated body manufacturing method shown in FIG. 12 is executed.

FIG. 13B is an operational explanatory drawing showing main parts of the manufacturing apparatus shown in FIG. 10 when the laminated body manufacturing method shown in FIG. 12 is executed.

FIG. 13C is an operational explanatory drawing showing main parts of the manufacturing apparatus shown in FIG. 10 when the laminated body manufacturing method shown in FIG. 12 is executed.

FIG. 14A is an operational explanatory drawing showing the state of the conveyor and the positioning mechanism of the manufacturing apparatus shown in FIG. 10 in the operating state shown in FIG. 13A.

FIG. 14B is an operational explanatory drawing showing the state of the conveyor and the positioning mechanism of the manufacturing apparatus shown in FIG. 10 in the operating state shown in FIG. 13B.

FIG. 14C is an operational explanatory drawing showing the state of the conveyor and the positioning mechanism of the manufacturing apparatus shown in FIG. 10 in the operating state shown in FIG. 13C.

FIG. 15A an explanatory drawing showing a state in which the positioning mechanism is in a holding position in the laminated body manufacturing apparatus pertaining to the second embodiment of the disclosure.

FIG. 15B is an explanatory drawing showing a state in which the positioning mechanism is in the holding position in the laminated body manufacturing apparatus pertaining to the second embodiment of the disclosure.

FIG. 16A is a plan view showing another example of a latching iron core member supplied to the laminated body manufacturing apparatus pertaining to each of the embodiments of the disclosure.

FIG. 16B is a sectional view taken along line B-B of FIG. 16A.

FIG. 17A is a plan view showing another example of a non-latching iron core member supplied to the laminated body manufacturing apparatus pertaining to each of the embodiments of the disclosure.

FIG. 17B is a sectional view taken along line C-C of FIG. 17A.

### DESCRIPTION OF EMBODIMENTS

This application is based on Japanese Patent Application No. 2023-007929 filed in Japan on Jan. 23, 2023, the contents of which form part of the contents of the present application.

Furthermore, the present disclosure will become more fully understood from the following detailed description. Further ranges of application of the present application will become apparent from the following detailed description. However, the detailed description and specific examples are preferred embodiments of the disclosure and are given only for the purpose of illustration. From this detailed description, a variety of changes and modifications will be apparent to those skilled in the art within the spirit and scope of the disclosure.

Applicant has no intention of dedicating any of the described embodiments to the public, and among the disclosed modifications and alternatives, those that might not literally fall within the scope of the claims are also to be regarded as part of the invention under the doctrine of equivalents.

Embodiments for implementing the disclosure will be described below with reference to the drawings. It will be noted that in the following, ranges that are necessary for description for achieving the object of the disclosure will be schematically described, ranges that are necessary for description of the relevant parts of the disclosure will be mainly described, and areas for which description is omitted will be based on publicly known technologies. Furthermore, identical or similar reference signs are assigned to mutually identical or corresponding members in the drawings, and redundant description will be omitted. Moreover, when a single drawing includes a plurality of mutually identical or corresponding members, reference signs may be assigned only to some of them in order to facilitate viewing of the drawing. Moreover still, unless otherwise noted in the specification, the constituent elements of the disclosure are not limited to one and may be present in plural numbers.

### First Embodiment

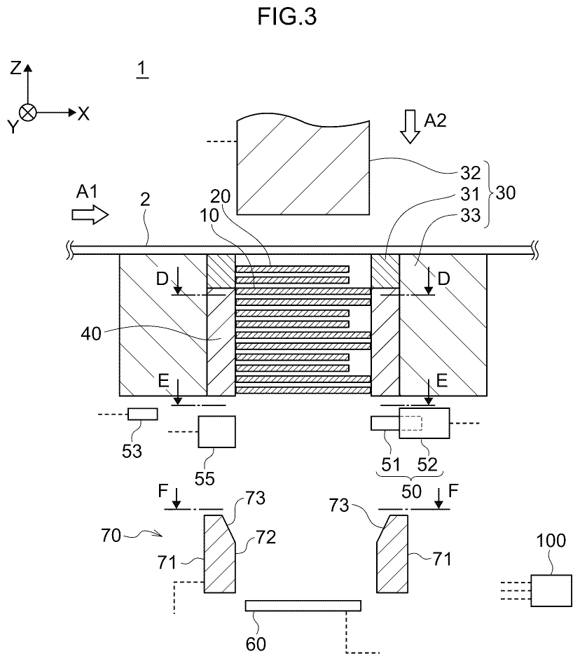

Before describing a laminated body manufacturing apparatus 1 (see FIG. 3) and a laminated body manufacturing method pertaining to a first embodiment, iron core members that configure a stack will be briefly described. The iron core members that are laminated in the present embodiment may configure a block core as a result of more than one being laminated, and the block core can, on its own or as a result of more than one being laminated, configure a motor core, such as a stator core of an inner rotor type rotating electric machine for example. It will be noted that “laminated body” in this disclosure refers to a plurality of iron core members that have simply been stacked, while a laminated body in which the iron core members have been joined together by welding or the like will be called a “motor core,” to distinguish between the two. Furthermore, the motor core may be either a divided stator core or a non-divided stator core and furthermore may configure a rotor core rather than a stator core.

Furthermore, the iron core members may be configured by two types, a latching iron core member 10 that has latching pieces 13 in a plurality of places on its outer peripheral surface and a non-latching iron core member 20 that does not have the latching pieces 13. Below, the configurations of each of the latching iron core member 10 and the non-latching iron core member 20 will be described.

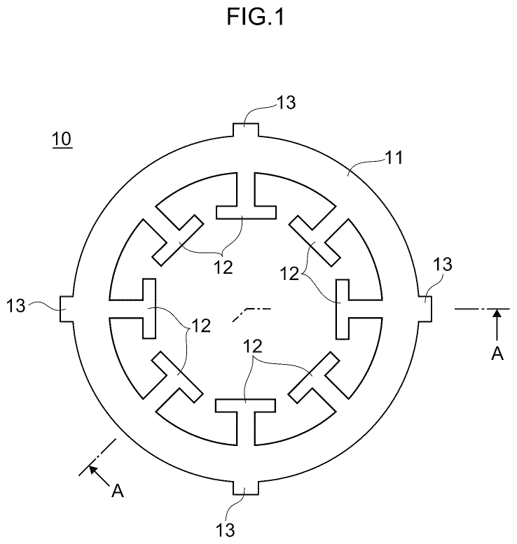

FIG. 1 is a drawing showing an example of a latching iron core member supplied to a laminated body manufacturing apparatus pertaining to a first embodiment of the disclosure. As shown in FIG. 1, the latching iron core member 10 can include an annular yoke 11 having formed in its center portion a through hole in which a rotor core is capable of being disposed, teeth 12 that are substantially T-shaped in plan view and provided on the inner periphery of the yoke 11 so as to project toward the center portion of the yoke 11, and latching pieces 13 configured by projections that project in an outward direction from the outer peripheral surface of the yoke 11. Furthermore, the latching iron core member 10 can be configured by a single plate-shaped electromagnetic steel sheet having a predetermined thickness (which is sometimes called a “core piece”).

The teeth 12 provided on the inner peripheral surface of the latching iron core member 10 may be provided in a plural number, such as eight for example, at substantially equal intervals along the inner peripheral surface. Armature coils can be wound around the teeth 12 when they are assembled into a stator core. It will be noted that the specific shape and arrangement of the teeth 12 can be changed as appropriate.

The latching pieces 13 provided on the outer peripheral surface of the latching iron core member 10 may be provided in a plural number, such as four for example, at substantially equal intervals along the outer periphery of the latching iron core member 10. In addition, the positions where the four latching pieces 13 are provided are, as shown in FIG. 1, preferably on the radial direction outer side of any of the eight teeth 12 provided on the inner peripheral surface of the latching iron core member 10. Normally, the density of the magnetic flux generated when the latching iron core member 10 is operated as part of a motor core tends to be lower on the radial direction outer side of the teeth 12 compared with other positions. Consequently, by disposing the latching pieces 13 on the radial direction outer side of the teeth 12 as described above, deterioration of the magnetic characteristics of the motor core caused by providing the latching pieces 13 can be inhibited.

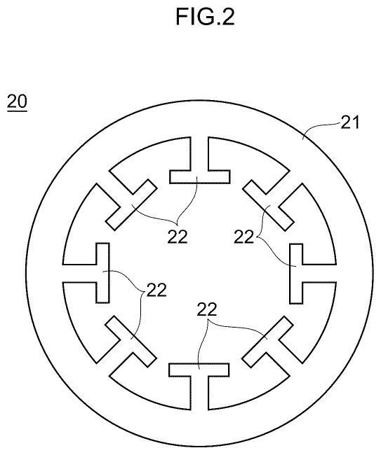

FIG. 2 is a drawing showing an example of a non-latching iron core member supplied to the laminated body manufacturing apparatus pertaining to the first embodiment of the disclosure. As shown in FIG. 2, the non-latching iron core member 20 can include an annular yoke 21 having formed in its center portion a through hole in which a rotor core is capable of being disposed and teeth 22 that are substantially T-shaped in plan view and provided on the inner peripheral surface of the yoke 21 so as to project toward the center portion of the yoke 21. Furthermore, the non-latching iron core member 20 can also be configured by a single plate-shaped electromagnetic steel sheet having a predetermined thickness. In other words, the non-latching iron core member 20 can be said to include the same configuration as the latching iron core member 10 except that it does not have the latching pieces 13 included in the latching iron core member 10. Consequently, the yoke 11 and teeth 12 of the latching iron core member 10 and the yoke 21 and teeth 22 of the non-latching iron core member 20 may have the same dimensions, arrangement, and number.

Below, an apparatus and method for manufacturing a laminated body using the latching iron core member 10 and the non-latching iron core member 20 having the above configurations will be described. It will be noted that the specific structures of the latching iron core member 10 and the non-latching iron core member 20 are not limited to those described above and are capable of being modified in a variety of ways. Representative specific examples will be described below.

### Laminated Body Manufacturing Apparatus

FIG. 3 is a schematic explanatory drawing showing an example of the laminated body manufacturing apparatus pertaining to the first embodiment of the disclosure. In FIG. 3, the latching iron core members 10 and the non-latching iron core members 20 are shown in a sectional view taken at a position corresponding to line A-A shown in FIG. 1. Furthermore, in FIG. 3, just the dimension of the latching pieces 13 is shown larger than the actual dimension in order to facilitate understanding of the state of the latching pieces 13, and illustration of the through holes and the teeth 12, 22 formed in the centers of the iron core members 10, 20 is omitted. Moreover, in FIG. 3, slight gaps are shown between the iron core members so that the boundaries between the iron core members, which are conveyed in a laminated state through a squeeze 40, can be seen.

As shown in FIG. 3, the laminated body manufacturing apparatus 1 pertaining to the present embodiment includes at least: a supply mechanism 30 capable of supplying the latching iron core members 10 and the non-latching iron core members 20; a squeeze 40 capable of conveying along the conveyance direction, while laterally supporting, the latching iron core members 10 and the non-latching iron core members 20 supplied from the supply mechanism 30; a conveyor 60 capable of receiving the latching iron core members 10 and the non-latching iron core members 20 that have been supplied from the conveyance direction downstream end portion of the squeeze 40; a separation mechanism 50 that is disposed between the squeeze 40 and the conveyor 60 in the conveyance direction of the iron core members and controls the supply of the iron core members to the conveyor 60; and a positioning mechanism 70 that positions the latching iron core members 10 and the non-latching iron core members 20 supplied onto the conveyor 60. It will be noted that, in the following, description will be given taking the direction indicated by arrow X shown in FIG. 3 as a left and right direction, and similarly below, taking the direction indicated by arrow Y as a front and rear direction, and taking the direction indicated by arrow Z as an up and down direction.

The supply mechanism 30 can include a press machine capable of selectively punching out the latching iron core members 10 and the non-latching iron core members 20 from a steel strip 2 conveyed in the direction of arrow Al in FIG. 3. The supply mechanism 30 can include a die (sometimes also called a lower die) 31 that supports a support table 33, which supports the conveyed steel strip 2, and a part of the steel strip 2 and a punch (sometimes also called an upper die) 32 that is disposed above the die 31. The punch 32 operates in the direction of arrow A2 in FIG. 3, whereby the latching iron core members 10 and the non-latching iron core members 20 can be punched from the steel strip 2.

FIG. 4 is a schematic sectional view taken along line D-D of FIG. 3. The squeeze 40 is disposed downstream of the supply mechanism 30 in the conveyance direction and is capable of conveying along the conveyance direction, while laterally supporting, the latching iron core members 10 and the non-latching iron core members 20 supplied from the supply mechanism 30. More specifically, as shown in FIG. 3 and FIG. 4, the squeeze 40 can be configured by a substantially cylindrical member having one end connected to the conveyance direction downstream end portion of the die 31 and, together with the die 31, is attached to the support table 33. The squeeze 40 can convey, in a mutually laminated state, the latching iron core members 10 and the non-latching iron core members 20 that have been punched and pushed out downward of the die 31.

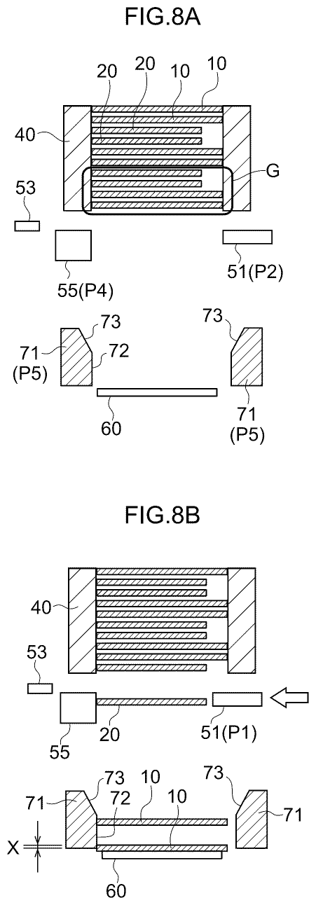

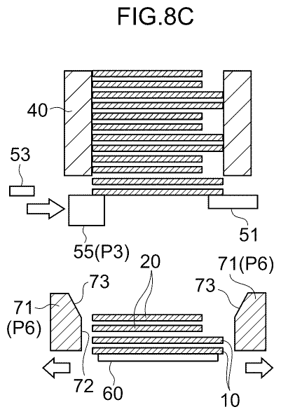

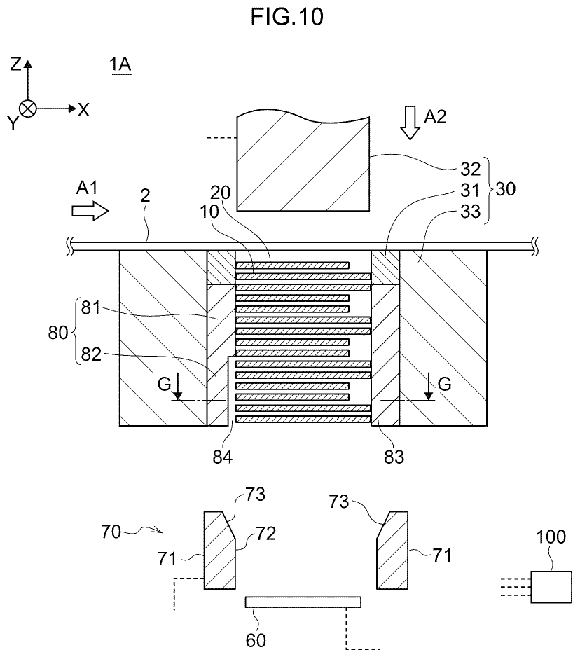

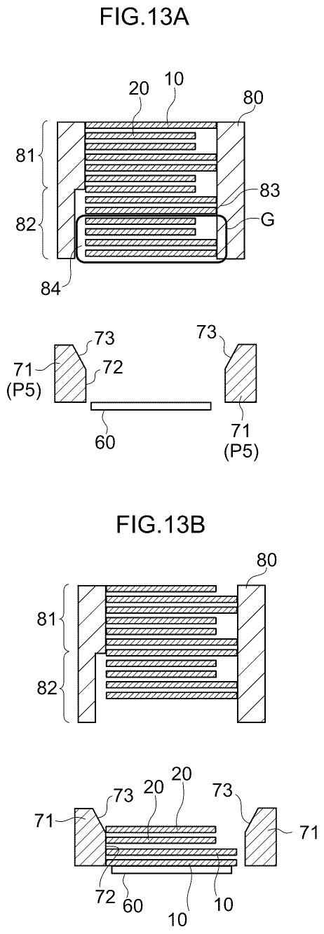

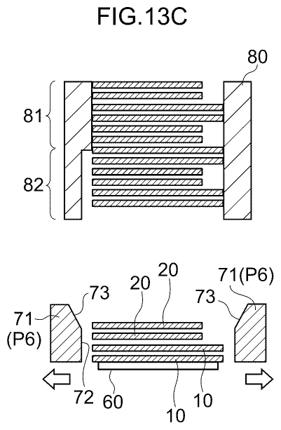

Furthermore, as shown in FIG. 4, an inner peripheral surface 41 of the squeeze 40 may be adjusted to a size matching the shapes of the latching iron core members 10 and the non-latching iron core members 20 that are conveyed. Because of this, the sides (i.e., outer peripheries) of the latching iron core members 10 and the non-latching iron core members 20 passing through the squeeze 40 can abut against and be supported by the inner peripheral surface 41 of the squeeze 40. It will be noted that although the inner peripheral surface 41 of the squeeze 40 pertaining to the present embodiment has a shape matching the outer peripheral shape of the latching iron core members 10, other structures can also be employed as long as they are structures that can laterally support the latching iron core members 10 and the non-latching iron core members 20. For example, the inner peripheral surface 41 may have a shape that abuts against only part of the outer peripheral surface of each of the iron core members. Furthermore, although in FIG. 3 and in FIG. 8, FIG. 10, and FIG. 13 described below only a comparatively small number of iron core members are shown being conveyed through the squeeze in order to facilitate understanding, the number of iron core members conveyable through the squeeze 40 may be from several dozens to several hundreds. Additionally, the total number of iron core members configuring a laminate may also be from several dozens to several hundreds.

The latching iron core members 10 and the non-latching iron core members 20 continuously supplied from the supply mechanism 30 can be sequentially conveyed into and supported by the upper end of the squeeze 40. Consequently, each time a new latching iron core member 10 or non-latching iron core member 20 is conveyed into the squeeze 40, the latching iron core members 10 and the non-latching iron core members 20 that were already being held inside the squeeze 40 are pushed by that conveyed latching iron core member 10 or non-latching iron core member 20 and become conveyed downward through the squeeze 40 by an amount corresponding to its thickness. It will be noted that although in FIG. 3 and in FIG. 8, FIG. 10, and FIG. 13 described below slight gaps are shown between the iron core members in order to facilitate understanding of the boundaries between the iron core members as described above, in actuality these gaps are not formed. That is, the latching iron core members 10 and the non-latching iron core members 20 that are adjacent inside the squeeze 40 in the present embodiment are conveyed in a laminated state, i.e., a state in which they are in contact with each other. The same also applies to the iron core members after they have been conveyed onto the conveyor 60 shown in FIG. 8 and FIG. 13.

The separation mechanism 50 may control the supply of the latching iron core members 10 and the non-latching iron core members 20 conveyed in the downward direction to the conveyor 60. The separation mechanism 50 includes at least latching portions 51, which contact the conveyed latching iron core members 10 and limit their movement, and an actuator 52, which serves as an example of an actuation device that operates the latching portions 51. It will be noted that the aforementioned downward direction corresponds to the conveyance direction of the iron core members 10, 20 in the present embodiment.

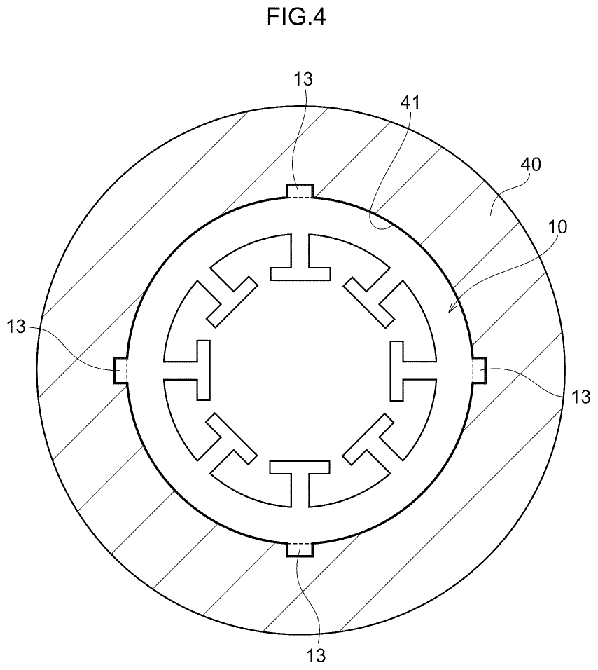

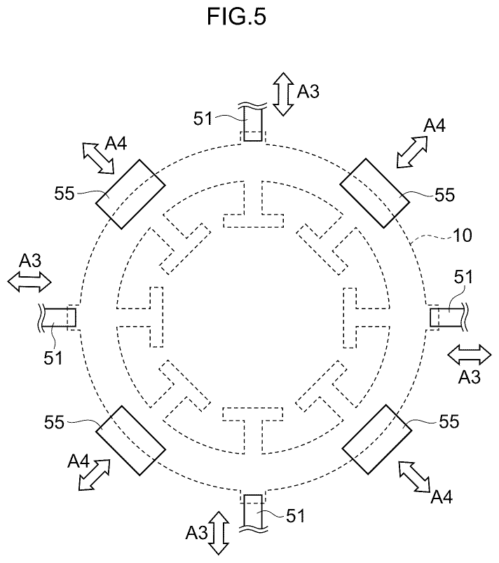

FIG. 5 is a schematic sectional view taken along line E-E of FIG. 3. As shown in FIG. 3 and FIG. 5, the latching portions 51 may be provided in a plural number around the conveyed iron core members, and specifically, four may be provided to match the number of the latching pieces 13 provided on the latching iron core members 10. The latching portions 51 can be configured to be movable between a latching position P1 (see FIG. 8B), where they latch each of the plurality of latching pieces 13 of the latching iron core members 10 conveyed out from the conveyance direction downstream end portion of the squeeze 40 such as shown in FIG. 5, and a non-latching position P2 (see FIG. 8A), where they do not latch the latching pieces 13 such as shown in FIG. 3. In other words, the latching position P1 can be set in an optional position on a moving path through which the latching pieces 13 of the latching iron core members 10 conveyed on a conveyance path pass, and the non-latching position P2 can be set in a position that does not coincide with the moving path of the latching pieces 13. It will be noted that in FIG. 5, in order to facilitate understanding of the relationship between the latching pieces 13 and the latching portions 51, the latching iron core member 10 that is conveyed through this position is indicated by dotted lines, and illustration of members positioned lower than the separation mechanism 50, such as the conveyor 60 for example, is omitted.

The actuator 52 can operate the latching portions 51. Specifically, the actuator 52 can operate the latching portions 51 in the directions indicated by arrows A3 in FIG. 5 for example so as to move them between the latching position P1 and the non-latching position P2. For the actuator 52 in the present embodiment, a known linear motion device such as an air cylinder or a single-axis robot can be employed. Because of the actuator 52, the latching portions 51 can be operated to move between the latching position P1, which is provided in a direction relatively close to the latching iron core members 10, and the non-latching position P2, which is provided in a direction relatively away from the latching iron core members 10. It will be noted that the directions in which the latching portions 51 are moved by the actuator 52 are not limited to those described above and can be changed as appropriate to match the shape of the latching pieces 13.

Furthermore, the separation mechanism 50 pertaining to the present embodiment can further include a sensor 53 capable of detecting that each of the iron core members has passed an optional position on the conveyance path. The optional position is preferably an optional position between the lower end portion of the squeeze 40 and the upper end portions of the latching portions 51 and is more preferably a position adjacent to the upper ends of the latching portions 51. For the sensor 53, a known sensing device, such as an infrared sensor or a two-dimensional camera for example, can be employed.

In this connection, the strength of the latching pieces 13 of the latching iron core members 10 is usually determined by their thickness and material. Additionally, when the separation mechanism 50 supports the latching iron core members 10, in addition to the weight of the latching iron core members 10 themselves including the latching pieces 13, the weight of the non-latching iron core members 20 that have been conveyed out from the squeeze 40 and laminated on the latching iron core members 10 also acts on the latching pieces 13. For that reason, these weights may cause the latching pieces 13 to deform, so that the supply of the iron core members to the conveyor 60 may become unable to be controlled. In consideration of this, the manufacturing apparatus 1 pertaining to the present embodiment preferably further includes a holding mechanism 55 in order to assist the support of the latching iron core members 10 by the latching pieces 13.

As shown in FIG. 3 and FIG. 5, the holding mechanism 55 may be provided in the same height position as the separation mechanism 50. Furthermore, the holding mechanism 55 may be capable of being operated to move between a latching position P3 (see FIG. 8C), where it is capable of supporting at least some of the parts of the outer peripheral edges of the latching iron core members 10 where the latching pieces 13 are not provided, and a non-latching position P4 (see FIG. 8A), where it does not support those parts of the outer peripheral edges. In order to stably support each of the iron core members, the length of the holding mechanism 55 in a direction along the outer peripheral surfaces of the latching iron core members 10 (hereinafter, this length will also be called a “width”) should be set larger than the width of the latching portions 51. The directions in which the holding mechanism 55 is operated may be the directions indicated by arrows A4 in FIG. 5, i.e., directions toward or away from the latching iron core members 10. By including the holding mechanism 55, the latching iron core members 10 supplied to the conveyor 60, or the latching iron core members 10 and the non-latching iron core members 20 laminated thereon, can be supported by two mechanisms, the separation mechanism 50 and the holding mechanism 55. For that reason, control of the supply of each of the iron core members to the conveyor 60 can be reliably executed.

The conveyor 60 may be capable of receiving on its upper surface the latching iron core members 10 and the non-latching iron core members 20 supplied through the separation mechanism 50 from the conveyance direction downstream end portion of the squeeze 40. When the conveyor 60 is operated, the latching iron core members 10 and the non-latching iron core members 20 that have been supplied and placed on the conveyor 60 can be conveyed in a direction intersecting the conveyance direction, such as for example the front and rear direction (hereinafter called “the conveyor conveyance direction”). It will be noted that the specific structure of the conveyor 60 is not particularly limited, and for example a known belt conveyor can be employed.

The conveyor 60 pertaining to the present embodiment does not need to be provided with a structure for regulating the horizontal direction positions of the latching iron core members 10 and the non-latching iron core members 20 that are supplied. This is because the horizontal direction positions of the latching iron core members 10 and the non-latching iron core members 20 are positioned by the positioning mechanism 70 described below. When there is no need to provide the conveyor 60 with a positioning structure for the latching iron core members 10 and the non-latching iron core members 20 as in the present embodiment, the structure of the conveyor 60 can be simplified and the placement positions of the latching iron core members 10 and the non-latching iron core members 20 can be freely changed, which is preferred.

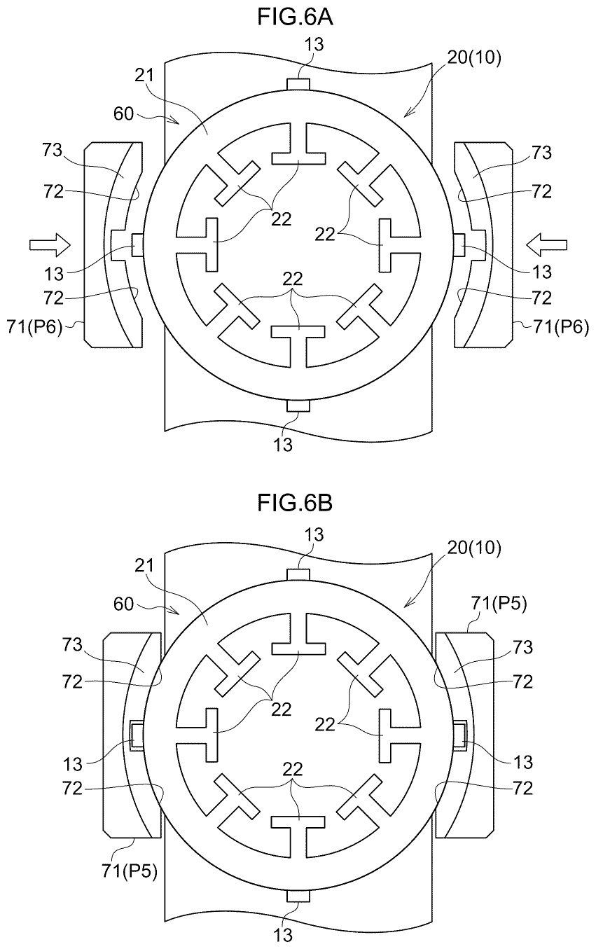

FIG. 6 are schematic structural drawings viewed from the position indicated by line F-F of FIG. 3, with FIG. 6A showing a state in which the positioning mechanism is in a positioning cancellation position in a state in which the iron core members have been placed on the conveyor, and with FIG. 6B showing a state in which the positioning mechanism is in a positioning position in a state in which the iron core members have been placed on the conveyor. As shown in FIG. 3 and FIG. 6, the positioning mechanism 70 is disposed between the conveyance direction downstream end portion of the squeeze 40 and the conveyor 60 in order to position the latching iron core members 10 and the non-latching iron core members 20 supplied onto the conveyor 60. The positioning mechanism 70 is movable in a direction toward and a direction away from side surfaces of the iron core members supplied from the conveyance direction downstream end portion of the squeeze 40. It will be noted that FIG. 3 shows the positioning mechanism 70 in a cross section, with a positioning piece 71 on the right side of the drawing being sectioned in a position opposing a latching piece 13 and with a positioning piece 71 on the left side of the drawing being sectioned in a position configuring an abutment surface 72.

The positioning mechanism 70 can be configured by a plurality, such as two for example, of positioning pieces 71 disposed on the outer peripheries of the latching iron core members 10 and the non-latching iron core members 20 placed on the conveyor 60. The plurality of positioning pieces 71 include abutment surfaces 72 that oppose the side surfaces of the latching iron core members 10 and the non-latching iron core members 20 placed on the conveyor 60. As shown in FIG. 6, the abutment surfaces 72 pertaining to the present embodiment may be formed by surfaces that are curved in plan view along the shapes of the side surfaces of the latching iron core members 10 and the non-latching iron core members 20 so that they can abut against the side surfaces of the latching iron core members 10 and the non-latching iron core members 20. It will be noted that the shape of the abutment surfaces 72 is not limited to the above shape as long as it is a shape that can position the latching iron core members 10 and the non-latching iron core members 20. For example, the shape may also be a shape that abuts against only parts of the outer peripheral shapes of the latching iron core members 10 and the non-latching iron core members 20. Furthermore, pins may be provided on the positioning pieces 71, and side surfaces of the pins may serve as abutment surfaces.

Furthermore, although in the present embodiment the positioning of the latching iron core members 10 and the non-latching iron core members 20 is performed by causing the abutment surfaces 72 of the plurality of positioning pieces 71 to abut against the latching iron core members 10 and the non-latching iron core members 20, the disclosure is not limited to this.

Specifically, as long as the latching iron core members 10 and the non-latching iron core members 20 are positioned in the region between the abutment surfaces 72, the positioning can be performed even if the abutment surfaces 72 do not abut against the latching iron core members 10 and the non-latching iron core members 20. Consequently, the side surfaces of the latching iron core members 10 and the non-latching iron core members 20 may abut against only parts of the abutment surfaces 72, or the abutment surfaces 72 may simply oppose the entire side surfaces of the latching iron core members 10 and the non-latching iron core members 20 via a predetermined gap. It will be noted that the predetermined gap can be set smaller than at least the gap between the abutment surfaces 72 in a positioning cancellation position P6 and the latching iron core members 10 and non-latching iron core members 20.

Since the abutment surfaces 72 are, as described above, configured by surfaces that are curved along the shapes of the side surfaces of the latching iron core members 10 and the non-latching iron core members 20, the iron core members 10 and the non-latching iron core members 20 that have been placed on the conveyor 60 can be supported from a variety of different directions. Consequently, horizontal direction positioning of the latching iron core members 10 and the non-latching iron core members 20 that have been positioned by the abutment surfaces 72 is stably implemented. It will be noted that recessed portions are preferably formed in the front and rear direction center portions of the abutment surfaces 72 in positions in the positioning pieces 71 opposing the latching pieces 13 in order for movement to a positioning position P5 to not be obstructed by contact between the abutment surfaces 72 and the latching pieces 13 when the positioning pieces 71 move. In this case, when the positioning pieces 71 are moved to the positioning position P5, as shown in FIG. 6B, the latching pieces 13 of the latching iron core members 10 that have been placed on the conveyor 60 become housed inside the recessed portions of the abutment surfaces 72. The positioning can be reliably implemented by avoiding contact between the latching pieces 13 of the latching iron core members 10 that have been placed on the conveyor 60 and the abutment surfaces 72. It will be noted that in a case where the latching iron core members 10 and the non-latching iron core members 20 have raised portions, recessed portions are preferably provided in the abutment surfaces 72 as described above, and in a case where the latching iron core members 10 and the non-latching iron core members 20 have recessed portions, raised portions are preferably provided on the abutment surfaces 72.

Although in the above embodiment an example was described where contact between the abutment surfaces 72 and the latching pieces 13 is avoided by providing recessed portions in the positioning pieces 71, the disclosure is not limited to this. The positioning by the abutment surfaces 72 may be assisted by actively causing parts of the recessed portions of the positioning pieces 71 to abut against the latching pieces 13 when the positioning pieces 71 are in the positioning position P5. In this case, an improvement in the stability of the positioning of the laminated body by the positioning pieces 71 can be expected.

Although in the present embodiment an example was described where the positioning mechanism 70 includes the pair of positioning pieces 71 whose abutment surfaces 72 oppose each other across the conveyor 60 in plan view, the arrangement and number of the positioning pieces 71 can be changed as appropriate. For example, four positioning pieces may be provided so as to surround, from the front and rear direction and the left and right direction, the outer peripheries of the latching iron core members 10 and the non-latching iron core members 20 placed on the conveyor 60.

Furthermore, the plurality of positioning pieces 71 may be movable between the positioning position P5, where the abutment surfaces 72 abut against the side surfaces of the latching iron core members 10 and the non-latching iron core members 20 placed on the conveyor 60 or where the abutment surfaces 72 oppose the side surfaces of the latching iron core members 10 and the non-latching iron core members 20 via a slight gap, and the positioning cancellation position P6, where the abutment surfaces 72 are away from the side surfaces of the latching iron core members 10 and the non-latching iron core members 20 placed on the conveyor 60. A known drive device not shown in the drawings can be used when moving the plurality of positioning pieces 71.

By positioning the plurality of positioning pieces 71 in the positioning position P5, the latching iron core members 10 and the non-latching iron core members 20 conveyed out from the squeeze 40 can be positioned in a desired position on the conveyor 60. Furthermore, by positioning the plurality of positioning pieces 71 in the positioning cancellation position P6, when the latching iron core members 10 and the non-latching iron core members 20 that have been placed on the conveyor 60 are moved in the conveyor conveyance direction, the positioning pieces 71 do not obstruct their movement.

The abutment surfaces 72 can include tapered surfaces 73 which, moving downstream in the conveyance direction, come nearer to the side surfaces of the latching iron core members 10 and the non-latching iron core members 20 placed on the conveyor 60. In the present embodiment, an example is described where the entire upper portions of the abutment surfaces 72 are configured as the tapered surfaces 73. By forming the tapered surfaces 73 on the abutment surfaces 72 in this way, the latching iron core members 10 and the non-latching iron core members 20 can be guided to the desired position on the conveyor 60 even when a misalignment occurs in the attitude or horizontal direction position of the latching iron core members 10 and the non-latching iron core members 20 conveyed out from the squeeze 40.

The height position of the plurality of positioning pieces 71 is preferably adjusted in order to reliably implement the positioning of the latching iron core members 10 and the non-latching iron core members 20 placed on the conveyor 60. Specifically, end portions, i.e., lower ends, of the abutment surfaces 72 of the plurality of positioning pieces 71 positioned downstream in the conveyance direction are preferably adjusted so as to be positioned lower than the position of an upper surface of the iron core member that has been directly placed on the conveyor 60, specifically the latching iron core member 10 positioned on the bottom. When the abutment surfaces 72 are adjusted to this height, it becomes possible to reliably position the latching iron core members 10 and the non-latching iron core members 20 placed on the conveyor 60. It will be noted that the lower ends of the positioning pieces 71 may also be positioned lower than the upper surface of the conveyor 60. In that case, the width of the conveyor 60 is preferably reduced to an extent that the conveyor 60 does not contact the positioning pieces 71 in the positioning position P5.

In order to control each of the aforementioned constituent elements, the manufacturing apparatus 1 pertaining to the present embodiment can further include a control device 100. The control device 100 may be communicably connected to each of the constituent elements via wired or wireless communication as indicated by the dotted lines in FIG. 3 for example. For the control device 100, a computer including a sequencer (a Programmable Logic Controller, or PLC) can be employed.

Since the laminated body manufacturing apparatus 1 pertaining to the present embodiment has the above configurations and particularly the configuration where the latching portions 51 of the separation mechanism 50 latch the latching pieces 13, the latching portions 51 do not contact the non-latching iron core members 20. Consequently, periods when the non-latching iron core members 20 pass the position on the conveyance path where the separation mechanism 50 is provided can be utilized as times for moving the latching portions 51 to the latching position P1. Because of this, in the laminated body manufacturing apparatus 1, a longer amount of time for moving the latching portions 51 to the latching position P1 than has conventionally been the case can be ensured, and the laminating of the iron core members can be accurately executed without employing devices with a fast response speed for the actuator 52 and the sensor 53 included in the separation mechanism 50. Consequently, laminating of the iron core members can be accurately and efficiently implemented without requiring special devices. Furthermore, the laminated body manufacturing apparatus 1 can be manufactured relatively inexpensively, and the frequency of maintenance can also be reduced.

In this connection, although an example has been described where, in the manufacturing apparatus 1, the latching pieces 13 are configured as projections that project from the outer peripheral surfaces of the latching iron core members 10 and the latching portions 51 are operated in directions toward or away from the center portions of the latching iron core members 10, the present disclosure is not limited to this. For example, instead of providing the latching pieces 13 on the latching iron core members 10, parts of the outer peripheral edges of the latching iron core members 10 may be utilized as latching pieces, and recessed portions may be formed in corresponding places in the non-latching iron core members 20. Furthermore, the direction in which the latching portions 51 are operated can also be a direction along the circumferential direction of the iron core members instead of along a direction along the radial direction of the iron core members.

Furthermore, in the laminated body manufacturing apparatus 1 pertaining to the present embodiment, the conveyor 60 can receive the latching iron core members 10 and the non-latching iron core members 20 conveyed out from the squeeze 40, so work to change the conveyor 60 in consideration of the shapes of the latching iron core members 10 and the non-latching iron core members 20 almost never occurs. That is, there is no need to prepare in advance multiple members (e.g., jigs) for receiving the latching iron core members 10 and the non-latching iron core members 20.

Moreover, although an example was described where, in the manufacturing apparatus 1, the latching pieces are configured by projections that project from the outer peripheral surfaces of the latching iron core members 10 and the separation mechanism 50 is provided on the outer side of the conveyance path of the iron core member, the latching pieces 13 can also be formed on the inner peripheral surfaces of the latching iron core members 10. In this case, the separation mechanism 50 is also preferably disposed on the inner peripheral surface side of the iron core members.

### Laminated Body Manufacturing Method

Next, a laminated body manufacturing method pertaining to the present embodiment will be described. In the following description, a case where the laminated body manufacturing apparatus 1 is used to manufacture a laminated body will be described as an example, but the laminated body manufacturing method of this disclosure can also be implemented by apparatus other than the manufacturing apparatus 1. The laminated body manufacturing method pertaining to the present embodiment, which is realized by the laminated body manufacturing apparatus 1, can be provided in the form of a program for causing a processor of the control device 100 that controls each of the constituent elements of the laminated body manufacturing apparatus 1 to execute predetermined operations or in the form of a non-transitory computer-readable recording medium in which the program is stored.

Examples of apparatus other than the manufacturing apparatus 1 that are capable of implementing the laminated body manufacturing method include apparatus where the separation mechanism 50 of the manufacturing apparatus 1 is disposed on the inner peripheral surface side of the iron core members. In this case, the latching pieces 13 of the latching iron core members 10 become formed on the inner peripheral surface of the yoke 11. It will be noted that the following description of effects and the like doubles as a description of the effects of the manufacturing apparatus 1 pertaining to the present embodiment.

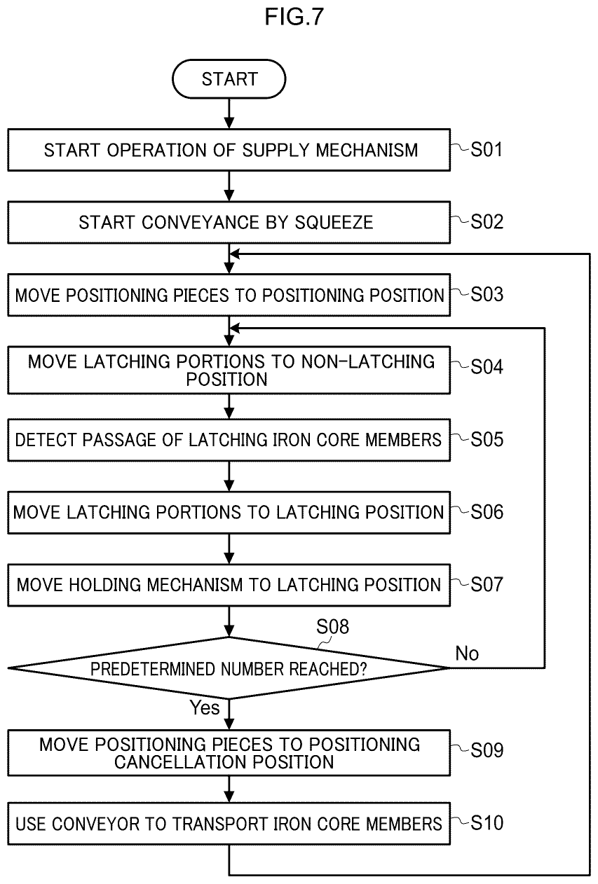

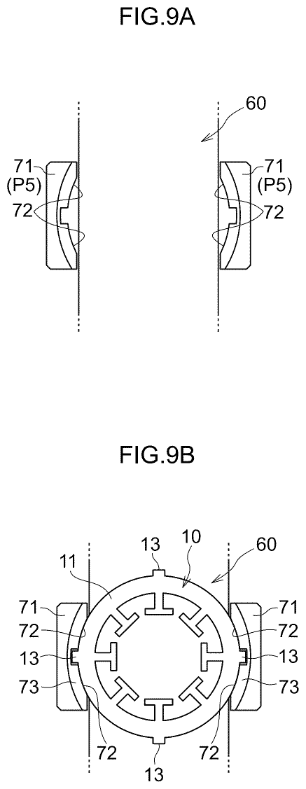

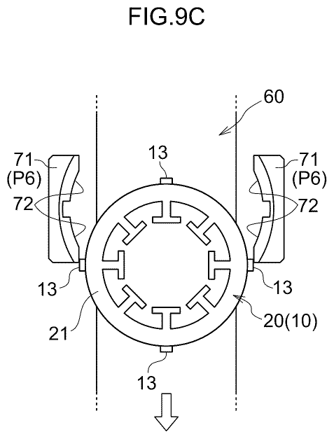

FIG. 7 is a flowchart showing an example of a laminated body manufacturing method pertaining to the first embodiment of the disclosure. Furthermore, FIG. 8 are operational explanatory drawings showing main parts of the manufacturing apparatus shown in FIG. 3 when the laminated body manufacturing method shown in FIG. 7 is executed. Moreover, FIG. 9 are operational explanatory drawings showing the state of the conveyor and the positioning mechanism of the manufacturing apparatus shown in FIG. 3 in each of the operating states shown in FIG. 8. It will be noted that in order to facilitate understanding of the state of conveyance of the iron core members conveyed from the squeeze 40 to the conveyor 60, FIG. 8 show only the parts of the manufacturing apparatus 1 relating to the conveyance and omit illustration of other parts. Furthermore, FIG. 8 show cross-sections in which the part of the positioning mechanism 70 on the left side of the drawings is sectioned at a part including the abutment surface 72 and the part of the positioning mechanism 70 on the right side is sectioned at a part housing a latching piece 13.

The laminated body manufacturing method pertaining to the present embodiment includes at least: a step (corresponding to step S01 described below) of supplying, from the supply mechanism 30, a plurality of iron core members including the latching iron core members 10 that have the latching pieces 13 in a plurality of places on their outer peripheral surfaces and the non-latching iron core members 20 that do not have the latching pieces; a step (corresponding to step S02 described below) of using the squeeze 40 to convey, while laterally supporting, the latching iron core members 10 and the non-latching iron core members 20 supplied from the supply mechanism 30; a step (corresponding to step S06 etc. described below) of using the separation mechanism to selectively support the iron core members supplied from the conveyance direction downstream end portion of the squeeze 40; a step (corresponding to step S03 described below) of moving, to the positioning position P5, the positioning mechanism 70 disposed between the separation mechanism 50 and the conveyor 60 in the conveyance direction in order to position the latching iron core members 10 and the non-latching iron core members 20 supplied onto the conveyor 60; a step (corresponding to step S04 described below) of moving the latching portions 51 from the latching position P1 to the non-latching position P2 in order to supply onto the conveyor 60 a plurality of the latching iron core members 10 and the non-latching iron core members 20 supported by the separation mechanism 50; a step (corresponding to step S06 described below) of returning the latching portions 51 that were moved to the non-latching position P2 to the latching position P1 during periods when the non-latching iron core members 20 are passing a position including the latching position P1; and when a predetermined number of the latching iron core members 10 and the non-latching iron core members 20 have been placed on the conveyor 60, a step (corresponding to step S09 described below) of moving the positioning mechanism 70 to the positioning cancellation position P6 and a step (corresponding to step S10 described below) of operating the conveyor 60 to transport, in the conveyor conveyance direction, the predetermined number of the latching iron core members 10 and the non-latching iron core members 20 that have been placed on the conveyor.

Describing now in greater detail the laminated body manufacturing method pertaining to the present embodiment, the manufacturing method first starts a punching operation using the punch 32 and the die 31 and starts supplying the latching iron core members 10 and the non-latching iron core members 20 to the squeeze 40 (step S01). This punching operation can be executed by lowering the punch 32 at a predetermined timing relative to the steel strip 2 being fed in one direction, e.g., the left and right direction. The latching iron core members 10 and the non-latching iron core members 20 formed by the punching move downward of the die 31 as a result of being pushed by the punch 32 and are pushed into the squeeze 40 from the upper end portion of the squeeze 40 connected to the die 31.

In this connection, in the present embodiment, the operation of the separation mechanism 50 and the transport by the conveyor 60 can be implemented each time an iron core member group G comprising four iron core members is conveyed out from the squeeze 40. In association with this, the latching iron core members 10 and the non-latching iron core members 20 punched in step S01 are preferably such that, among the plurality (four in FIG. 8) of iron core members configuring the one iron core member group G, the latching iron core members 10 make up one or a plurality of the iron core members positioned downstream and the non-latching iron core members 20 make up the remaining iron core members positioned upstream. In other words, of the plurality of iron core members configuring the one iron core member group G, at least the first core member to be punched is a latching iron core member 10 while the rest are non-latching iron core members 20. This is because it is necessary to support the iron core member positioned most downstream in the iron core member group G when the separation mechanism 50 temporarily stops the supply of each of the iron core members to the conveyor 60.

At least parts of the outer peripheral surfaces of the latching iron core members 10 and the non-latching iron core members 20 that have been pushed into the squeeze 40 are laterally supported by the inner peripheral surface 41 of the squeeze 40. Additionally, the laterally supported latching iron core members 10 and non-latching iron core members 20 are conveyed in a laminated state in the downward direction through the squeeze 40 (step S02). The conveyance of the iron core members by the squeeze 40 may be executed as a result of a new iron core member being conveyed in from the supply mechanism 30 to the upper end portion of the squeeze 40 and this iron core member pushing down the other iron core members that were previously supplied from the supply mechanism 30 and are being held inside the squeeze 40. Consequently, the iron core members held in the squeeze 40 are conveyed along the conveyance direction while maintaining their laminated state. The operations described in steps S01 and S02 can be started substantially at the same time in conjunction with starting the operation of the punch 32.

Furthermore, in the present embodiment, an example is described where two each of the latching iron core members 10 and the non-latching iron core members 20 are alternately punched, so that two each of the latching iron core members 10 and the non-latching iron core members 20 are alternately conveyed through the squeeze 40. In association with this, one iron core member group G is configured as a result of two of the latching iron core members 10 and two of the non-latching iron core members 20 being sequentially laminated from the downstream side.

When the conveyance of the latching iron core members 10 and the non-latching iron core members 20 by the squeeze 40 is started, the positioning pieces 71 are moved to the positioning position P5 as shown in FIG. 9A in order to position the latching iron core members 10 and the non-latching iron core members 20 that are next conveyed out from the squeeze 40 (step S03). It will be noted that the timing of the initial movement of the positioning pieces 71 to the positioning position P5 may be earlier than this.

When a predetermined amount of time elapses since the conveyance of the iron core members by the squeeze 40 has started, the iron core members are sequentially conveyed out from the lower end portion of the squeeze 40 toward the conveyor 60. When this outbound conveyance of the iron core members is started, the actuator 52 of the separation mechanism 50 is operated to move the latching portions 51 to the non-latching position P2 (step S04). It will be noted that in a case where the latching portions 51 are in the non-latching position P2 in the initial state of the manufacturing apparatus 1 as shown in FIG. 8A, step S04 may be skipped. Furthermore, in a case where the holding mechanism 55 is in the latching position P3 at this point in time, it is similarly moved to the non-latching position P4.

When the latching portions 51 are in the non-latching position P2, the latching portions 51 are not present on the conveyance path of the iron core members, so the iron core members configuring one iron core member group G conveyed out from the squeeze 40 at this timing sequentially move in the downward direction and become placed on the conveyor 60 and laminated as shown in FIG. 9B. At this time, the latching iron core members 10 and the non-latching iron core members 20 that have been conveyed out from the squeeze 40 are guided to a desired position on the conveyor 60 by the positioning pieces 71 disposed in the positioning position P5. Furthermore, the height of the lower end portions of the positioning pieces 71 is, as shown in FIG. 8B, adjusted so as to be positioned a distance X lower than the upper surface of the iron core member directly placed on the conveyor 60, i.e., the latching iron core member 10 positioned most downstream in the iron core member group G. For that reason, the positioning mechanism 70 can reliably implement positioning of all the iron core members placed on the conveyor 60.

The movement of the latching iron core members 10 and the non-latching iron core members 20 that have been conveyed out from the squeeze 40 is preferably monitored by the sensor 53. The sensor 53 may be disposed facing a position in the up and down direction including the latching position P1 where the latching portions 51 of the separation mechanism 50 latch the latching pieces 13 of the latching iron core members 10 (hereinafter, this position will be called an “iron core member support position”). Because of this, the sensor 53 can detect that the latching iron core members 10 have passed the iron core member support position.

When the passage of the latching iron core members 10 in the iron core member group G is detected by the sensor 53 or the like (step S05), the actuator 52 of the separation mechanism 50 is operated to start moving the latching portions 51 to the latching position P1 as shown in FIG. 8B (step S06). Here, the passage of the latching iron core members 10 through the iron core member support position refers to the passage, through the iron core member support position, of the latching iron core member 10 positioned most upstream in the one iron core member group G (the second latching iron core member from the bottom in FIG. 8B).

The method of detecting the passage of the latching iron core members 10 through the iron core member support position is not limited to the above. For example, the detection may be alternatively performed by detecting that the iron core members sequentially passing the iron core member support position have changed from the latching iron core members 10 to the non-latching iron core members 20, or based on the timing of the passage of the latching iron core members 10 through the iron core member support position identified by calculation without using a sensor, taking into account the number of iron core members supplied from the supply mechanism 30 and the supply time. Such alternative detection method generally tend to have a lower detection accuracy compared with using the sensor 53 to directly detect the passage of the latching iron core members 10. However, in the laminated body manufacturing method pertaining to the present embodiment, it is also possible to employ the aforementioned alternative detection method because, as described below, a long amount of time is ensured for the separation mechanism 50 to move from the non-latching position P2 to the latching position P1.

The movement of the latching portions 51 to the latching position P1 in step S06 is preferably completed during the period from when the latching iron core member 10 positioned most upstream in one iron core member group G passes through the iron core member support position to until the latching iron core member 10 positioned most downstream in another iron core member group G conveyed after the first iron core member group G reaches the iron core member support position. This period includes the period during which the two non-latching iron core members 20 pass the iron core member support position as shown in FIG. 8B, but the non-latching iron core members 20 do not have the latching pieces 13, and furthermore the latching position P1 of the latching portions 51 is set on the moving path of the latching pieces 13. For that reason, even if the latching portions 51 are in the latching position P1 at the timing when the non-latching iron core members 20 pass through the iron core member support position, the latching portions 51 do not hinder the conveyance of the non-latching iron core members 20.

When the movement of the latching portions 51 to the latching position P1 is completed, next, as shown in FIG. 8C, the movement of the holding mechanism 55 from the non-latching position P4 to the latching position P3 is started (step S07). The timing of the movement of the holding mechanism 55 to the latching position P3 can be set just after the latching iron core members 10 are latched by the latching portions 51 or after a plurality of the latching iron core members 10 (and, depending on the case, a plurality of the latching iron core members 10 and the non-latching iron core members 20) are supported by the latching portions 51.

When the support of the iron core member group G by the latching portions 51 and the holding mechanism 55 is completed, it is detected whether the number of the latching iron core members 10 and the non-latching iron core members 20 that have been placed on the conveyor 60 has reached a predetermined number, and if it has not reached the predetermined number (No in step S08), the process returns to step S04 and a new core member group G is supplied onto the conveyor 60. Here, the predetermined number is an optional number preset by the user for example.

On the other hand, if the number of the latching iron core members 10 and the non-latching iron core members 20 that have been placed on the conveyor 60 has reached the predetermined number (Yes in step S08), these iron core members are transported as a laminated body to a predetermined position, e.g., a position where a subsequent process is implemented. Specifically, first, as shown in FIG. 8C and FIG. 9C, the positioning pieces 71 are operated to move to the positioning cancellation position P6, which is a position where the positioning pieces 71 do not contact the laminated body transported by the conveyor 60 (step S09). Next, the conveyor 60 is operated to transport the predetermined number of the iron core members that have been placed on the conveyor 60 to the predetermined position (step S10). Then, when this transport work is completed, the process returns to step S03, where the positioning pieces 71 are again moved to the positioning position P5 and then the process of supplying a new iron core member group G onto the conveyor 60 is implemented.

As described above, according to the laminated body manufacturing method pertaining to the present embodiment, the latching portions 51 of the separation mechanism 50 and the latching pieces 13 are brought into contact with each other to control the supply of the iron core members, so a longer amount of time for moving the latching portions 51 than has conventionally been the case can be ensured. Because of this, special devices, and specifically devices with a fast response speed, no longer need be used for the constituent elements of the separation mechanism 50. Furthermore, the latching portions 51 can be reliably moved to the latching position P1, and the latching of the latching portions 51 and the latching pieces 13 can be stably executed.

Furthermore, according to the laminated body manufacturing method pertaining to the present embodiment, the plurality of iron core members conveyed out from the squeeze 40 are placed in a desired position on the conveyor 60 by the positioning mechanism 70, so there is no need to separately position the iron core members. Furthermore, since a predetermined number of the iron core members can be transported using the conveyor 60, there is no need to prepare multiple jigs as has conventionally been the case in order to laminate variously shaped iron core members.

As an option, although in the above embodiment an example was described where one iron core member group G was configured such that the downstream two iron core members are latching iron core members 10 and the two upstream iron core members are non-latching iron core members 20, it may also be configured such that just one downstream iron core member is a latching iron core member 10 and the remaining three iron core members are non-latching iron core members 20. By increasing the number of non-latching iron core members 20 configuring the iron core member group G in this way, a longer amount of time for moving the separation mechanism 50 can be ensured.

As an option, although in the above embodiment an example was described where the laminated body manufacturing method includes a step of moving the holding mechanism 55 to the latching position (step S07), instead of this step, a step of improving the force with which the iron core members are supported by the latching portions 51 can also be employed. Specifically, a step of moving the latching portions 51 to a position (corresponding to a holding position) where they latch not only the latching pieces 13 but also at least parts of the outer peripheral edges of the latching iron core members 10 can also be employed. In a case where the latching portions 51 operate in the directions indicated by arrows A3 in FIG. 5, by setting as a holding position a position at which the latching portions 51 are moved in a direction closer to the center portions of the latching iron core members 10 than they are in the latching position P1, the force with which the iron core members are supported by the latching portions 51 can be improved without using the holding mechanism 55, and stable support of the iron core members can be realized.

### Second Embodiment

In the first embodiment, an example was described where the separation mechanism 50 was used to control the supply of the iron core members to the conveyor 60, but the disclosure is not limited to such a structure. Thus, below, as a second embodiment of the present disclosure, a laminated body manufacturing apparatus and a laminated body manufacturing method that do not use the separation mechanism 50 will be described.

### Laminated Body Manufacturing Apparatus

A manufacturing apparatus 1A pertaining to the present embodiment may include the same configurations as those of the manufacturing apparatus 1 pertaining to the first embodiment except that it does not have members such as the separation mechanism 50 and the structure of the squeeze is different. Therefore, below, parts comprising the same configurations as those of the manufacturing apparatus 1 pertaining to the first embodiment are assigned reference numerals identical to those used in the description of the first embodiment, description thereof is omitted, and configurations different from those of the manufacturing apparatus 1 pertaining to the first embodiment will be mainly described.

FIG. 10 is a schematic explanatory drawing showing an example of a laminated body manufacturing apparatus pertaining to a second embodiment of the disclosure. FIG. 10 is drawn so as to correspond to FIG. 3. As shown in FIG. 10, a laminated body manufacturing apparatus 1A pertaining to the present embodiment includes: a second squeeze 80 capable of conveying in a downward direction the latching iron core members 10 and the non-latching iron core members 20 shown in FIG. 1 and FIG. 2 for example; a supply mechanism 30 that is positioned above the second squeeze 80 and is capable of selectively supplying the iron core members to the second squeeze 80; a conveyor 60 that can be positioned under the second squeeze 80 and is capable of receiving the iron core members supplied from the conveyance direction downstream end portion of the second squeeze 80; and a positioning mechanism 70 that positions the iron core members supplied onto the conveyor 60. It will be noted that the shapes of the iron core members laminated by the laminated body manufacturing apparatus 1A pertaining to the present embodiment are, as in the laminated body manufacturing apparatus 1 pertaining to the first embodiment, not limited to those shown in FIG. 1 and FIG. 2.

The second squeeze 80 can be configured by a substantially cylindrical member that conveys to the conveyor 60 the latching iron core members 10 and the non-latching iron core members 20 that have been punched by the supply mechanism 30 including the die 31 and the punch 32 and pushed out downward of the die 31. In addition, the second squeeze 80 includes a squeeze upstream portion 81 that is positioned upstream in the conveyance direction of the iron core members and laterally supports both the latching iron core members 10 and the non-latching iron core members 20 passing through the second squeeze 80 and a squeeze downstream portion 82 that is positioned downstream in the conveyance direction of the iron core members and laterally supports the latching pieces 13 of the latching iron core members 10 passing through the second squeeze 80.

The squeeze upstream portion 81 may have the same configuration as the squeeze 40 of the first embodiment. That is, its inner peripheral surface may have a shape identical to that of the inner peripheral surface 41 of the squeeze 40 shown in FIG. 4.

FIG. 11 is a schematic sectional view taken along line G-G of FIG. 10. As shown in FIG. 11, the squeeze downstream portion 82 may have, in positions on its inner peripheral surface opposing the latching pieces 13 of the latching iron core members 10, first latching portions 83 that laterally abut against the latching pieces 13 and support the latching iron core members 10.

Here, the fact that the parts of the inner peripheral surface of the squeeze downstream portion 82 other than the parts where the first latching portions 83 are formed do not support either the latching iron core members 10 or the non-latching iron core members 20 is an item that should be particularly noted. In the laminated body manufacturing apparatus 1A pertaining to the present embodiment, gaps 84 are formed between the parts of the inner peripheral surface of the squeeze downstream portion 82 excluding the parts where the first latching portions 83 are formed and the outer peripheral surfaces of the iron core members. It will be noted that the shape of the inner peripheral surface of the squeeze downstream portion 82 may be changed as appropriate to match the shapes of the latching iron core member 10 and the non-latching iron core members 20 that are conveyed.

Because the laminated body manufacturing apparatus 1A pertaining to the present embodiment includes the second squeeze 80, only the latching iron core members 10 are conveyed in a supported state in the squeeze downstream portion 82, and the non-latching iron core members 20 move on the conveyance path, without being laterally supported by the second squeeze 80, in a state in which they are placed on the upper surface of the latching iron core member 10 positioned downstream. Additionally, the non-latching iron core members 20 are conveyed out from the second squeeze 80 at the same time that the latching iron core members 10 positioned downstream of them are conveyed out from the lower end portion of the second squeeze 80.

As described above, by giving the laminated body manufacturing apparatus 1A a configuration where the outbound conveyance of the non-latching iron core members 20 and the outbound conveyance of the latching iron core members 10 are performed at the same time, the interval of time from when the non-latching iron core members 20 are conveyed out to when the latching iron core members 10 are next conveyed out from the lower end portion of the second squeeze 80 becomes longer. Consequently, the transport by the conveyor 60 can be performed at this timing, and laminating of the iron core members can be continuously and accurately executed without stopping the apparatus for the transport or using special devices for controlling the supply timing of the iron core members.

In addition, in the laminated body manufacturing apparatus 1A pertaining to the present embodiment also, as in the laminated body manufacturing apparatus 1 pertaining to the first embodiment, the conveyor 60 can receive the latching iron core members 10 and the non-latching iron core members 20 conveyed out from the second squeeze 80, so work to change the conveyor 60 in consideration of the shapes of the latching iron core members 10 and the non-latching iron core members 20 almost never occurs. That is, there is no need to prepare in advance multiple members (e.g., jigs) for receiving the latching iron core members 10 and the non-latching iron core members 20.

### Laminated Body Manufacturing Method

Next, a laminated body manufacturing method pertaining to the present embodiment will be described. In the following description, a case where the laminated body manufacturing apparatus 1A is used to manufacture a laminated body will be described as an example, but the laminated body manufacturing method of this disclosure can also be implemented by apparatus other than the laminated body manufacturing apparatus 1A. It will be noted that the following description of effects and the like doubles as a description of the effects of the manufacturing apparatus 1A pertaining to the present embodiment.

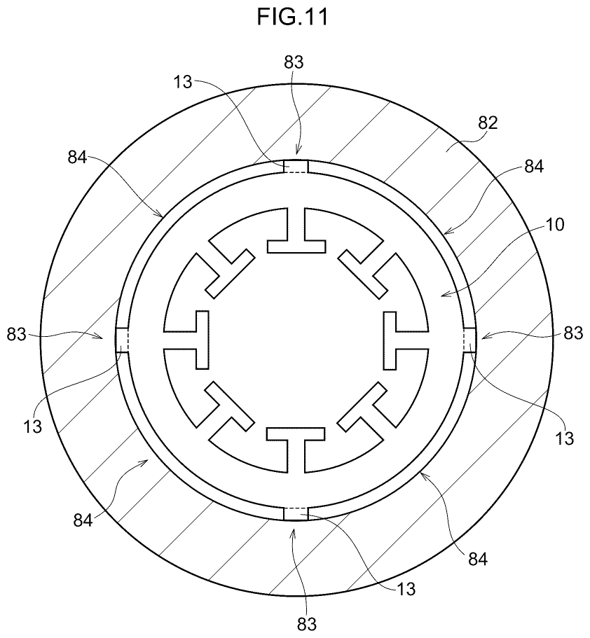

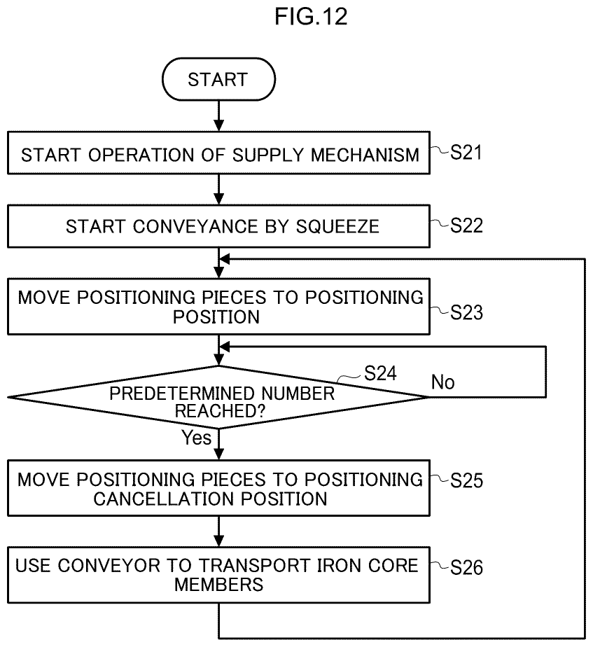

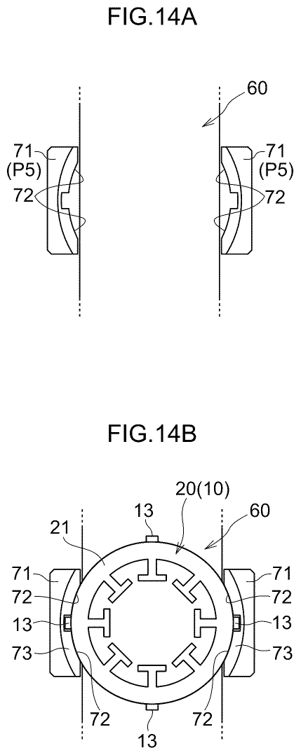

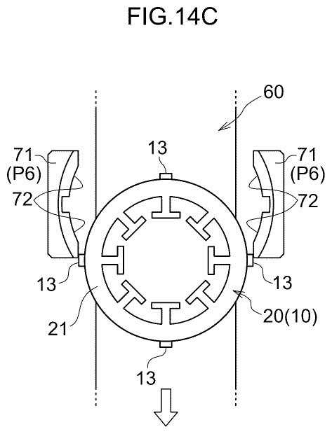

FIG. 12 is a flowchart showing an example of a laminated body manufacturing method pertaining to the second embodiment of the disclosure. Furthermore, FIG. 13 are operational explanatory drawings showing main parts of the manufacturing apparatus shown in FIG. 10 when the laminated body manufacturing method shown in FIG. 12 is executed. Moreover, FIG. 14 are operational explanatory drawings showing the state of the conveyor and the positioning mechanism of the manufacturing apparatus shown in FIG. 10 in each of the operating states shown in FIG. 13. It will be noted that in order to facilitate understanding of the state of conveyance of the iron core members conveyed from the second squeeze 80 to the conveyor 60, FIG. 13 show only the parts of the manufacturing apparatus 1A relating to the conveyance and omit illustration of other parts.

The laminated body manufacturing method pertaining to the present embodiment includes at least: a step (corresponding to step S21 described below) of supplying, to a squeeze, a plurality of iron core members including the latching iron core members 10 and the non-latching iron core members 20; a step (corresponding to step S23 described below) of moving the positioning mechanism 70 to the positioning position P5 in order to position the iron core members supplied from the lower end of the second squeeze 80 onto the conveyor 60; a step of supplying the latching iron core members 10 and the non-latching iron core members 20 from the lower end of the second squeeze 80 onto the conveyor 60; and, when a predetermined number of the iron core members have been placed on the conveyor 60, a step (corresponding to steps S25 and S26 described below) of moving the positioning mechanism 70 to the positioning cancellation position P6 and conveying, in a direction intersecting the conveyance direction, the predetermined number of the iron core members that have been placed on the conveyor 60.

Describing now in greater detail the laminated body manufacturing method pertaining to the present embodiment, the manufacturing method first starts a punching operation using the punch 32 and the die 31 and starts supplying the latching iron core members 10 and the non-latching iron core members 20 to the second squeeze 80 (step S21). This punching operation can be executed by lowering the punch 32 at a predetermined timing relative to the steel strip 2 being fed in one direction, e.g., the left and right direction. The latching iron core members 10 and the non-latching iron core members 20 formed by the punching move downward of the die 31 as a result of being pushed by the punch 32 and are pushed into the second squeeze 80 from the upper end portion of the second squeeze 80 connected to the die 31.

In this connection, in the present embodiment, the transport by the conveyor 60 can be implemented each time an iron core member group G comprising four iron core members is conveyed out from the second squeeze 80. In association with this, the latching iron core members 10 and the non-latching iron core members 20 punched in the step S21 are preferably such that, among the plurality (four in FIG. 13) of iron core members configuring the one iron core member group G, the latching iron core members 10 make up one or a plurality of the iron core members positioned downstream and the non-latching iron core members 20 make up the remaining iron core members positioned upstream. In the present embodiment, an example is described where two each of the latching iron core members 10 and the non-latching iron core members 20 are alternately punched, so that two each of the latching iron core members 10 and the non-latching iron core members 20 are alternately conveyed through the second squeeze 80.

At least parts of the outer peripheral surfaces of the latching iron core members 10 and the non-latching iron core members 20 that have been pushed into the second squeeze 80 are laterally supported by the inner peripheral surface of the second squeeze 80 and particularly the inner peripheral surface of the squeeze upstream portion 81. Additionally, the laterally supported latching iron core members 10 and non-latching iron core members 20 are conveyed in a laminated state in the downward direction through the second squeeze 80 (step S22). The latching iron core members 10 and the non-latching iron core members 20 that have been pushed into the second squeeze 80 are, in the squeeze upstream portion 81, conveyed along the conveyance direction while maintaining a state in which both the latching iron core members 10 and the non-latching iron core members 20 are laterally supported and laminated.

When the conveyance of the latching iron core members 10 and the non-latching iron core members 20 by the second squeeze 80 is started, the positioning pieces 71 are moved to the positioning position P5 as shown in FIG. 14A in order to position the latching iron core members 10 and the non-latching iron core members 20 that are next conveyed out from the second squeeze 80 (step S23). It will be noted that the timing of the initial movement of the positioning pieces 71 to the positioning position P5 may be earlier than this.

When the conveyance of the iron core members through the second squeeze 80 progresses and some of the iron core members reach the squeeze downstream portion 82, the lateral support of the latching iron core members 10 of the iron core members is maintained as a result of the latching pieces 13 coming into contact with the latching portions 83. On the other hand, the lateral support of the non-latching iron core members 20 is canceled, and the non-latching iron core members 20 are supported by the upper surface of the latching iron core member 10 positioned downstream of them (see FIG. 13A).

When the conveyance of the iron core members by the second squeeze 80 progresses further, first, the latching iron core member 10 positioned most downstream among the iron core members configuring the one iron core member group G is conveyed out from the lower end portion of the second squeeze 80. Next, the latching iron core member 10 (hereinafter, to facilitate understanding of the description, this latching iron core member 10 will for the present be called “the second latching iron core member 10”) that had been conveyed through the squeeze downstream portion 82 in a laminated state with its lower surface abutting against the upper surface of the latching iron core member 10 positioned most downstream is conveyed out from the lower end portion of the second squeeze 80.

Here, the second latching iron core member 10 has the two non-latching iron core members 20 included in the same iron core member group G placed on its upper surface. The non-latching iron core members 20 are not laterally supported by the squeeze downstream portion 82, so when the second latching iron core member 10 is conveyed out from the lower end portion of the second squeeze 80, the two non-latching iron core members 20 are also conveyed out from the lower end portion of the second squeeze 80 at the same time. Additionally, at this time, the latching iron core members 10 that had been laminated upstream of the two non-latching iron core members 20 that were conveyed out are conveyed through a position away from the lower end portion of the second squeeze 80.

As shown in FIG. 13B and FIG. 14B, when the second latching iron core member 10 and the two non-latching iron core members 20 supported on its upper surface are placed on the conveyor 60, the number of the latching iron core members 10 and the non-latching iron core members 20 that have been placed on the conveyor 60 is detected. If the number of the latching iron core members 10 and the non-latching iron core members 20 on the conveyor 60 has not reached the predetermined number (No in step S24), the process waits until the predetermined number is reached. On the other hand, when it is detected that the predetermined number has been reached (Yes in step S24), these iron core members are transported as a laminated body to a predetermined position, e.g., a position where a subsequent process is implemented. Here, at the timing when the transport of the laminated body is performed, the next latching iron core members 10 to be conveyed to the conveyor 60 are conveyed through a position away from the lower end portion of the second squeeze 80 as described above. Consequently, a relatively long amount of time is ensured before the latching iron core members 10 being conveyed through the second squeeze 80 are conveyed out from the lower end portion of the second squeeze 80. Because of this, the need to temporarily stop the apparatus when transporting the laminated body is essentially eliminated.

Specifically describing now the work in which the laminated body is transported by the conveyor 60, first, as shown in FIG. 13C and FIG. 14C, the positioning pieces 71 are moved to the positioning cancellation position P6 (step S25). Next, the conveyor 60 is operated to transport the predetermined number of the iron core members that have been placed on the conveyor 60 to the predetermined position (step S26). Then, when this transport work is completed, the process returns to step S23, where the positioning pieces 71 are again moved to the positioning position P5 and then the process of supplying a new iron core member group G onto the conveyor 60 is implemented. By implementing step S23 before new iron core members are conveyed out from the lower end of the second squeeze 80, laminated body can be continuously manufactured without stopping the apparatus.

As described above, according to the laminated body manufacturing method pertaining to the present embodiment, by simply modifying a part of the inner peripheral surface of the second squeeze 80, the timing of the outbound conveyance of the iron core members conveyed out from the lower end portion of the second squeeze 80 can be adjusted. Consequently, the manufacture of laminated body can be continuously performed with a simple structure. Furthermore, because the squeeze downstream portion 82 has a structure that supports only the latching iron core members 10, each time an iron core member group G is conveyed out, a long amount of time is ensured until the next outbound conveyance, so the transport of the laminated body by the conveyor 60 can be executed without stopping the apparatus.

Furthermore, according to the laminated body manufacturing method pertaining to the present embodiment, the plurality of iron core members conveyed out from the second squeeze 80 are placed in a desired position on the conveyor 60 by the positioning mechanism 70, so there is no need to separately position the iron core members. Furthermore, since a predetermined number of the iron core members can be transported using the conveyor 60, there is no need to prepare multiple jigs as has conventionally been the case in order to laminate variously shaped iron core members.

In this connection, in the laminated body manufacturing method pertaining to the present embodiment, the latching iron core members 10 and the non-latching iron core members 20 conveyed out from the second squeeze 80 are directly supplied to the conveyor 60. Here, since the conveyor 60 transports the laminated body to a subsequent process, it can be stopped or driven in the middle of the manufacturing method in a case where, for example, an abnormality occurs in the subsequent process and the user wants to temporarily stop supplying the laminated body to the subsequent process. In order to handle such unintended driving or stopping of the conveyor 60, the laminated body manufacturing apparatus and manufacturing method pertaining to the present embodiment can be configured to be capable of temporarily holding the latching iron core members 10 and the non-latching iron core members 20 conveyed out from the second squeeze 80. Below, a structure and a process for temporarily holding the latching iron core members 10 and the non-latching iron core members 20 conveyed out from the second squeeze 80 will be described.

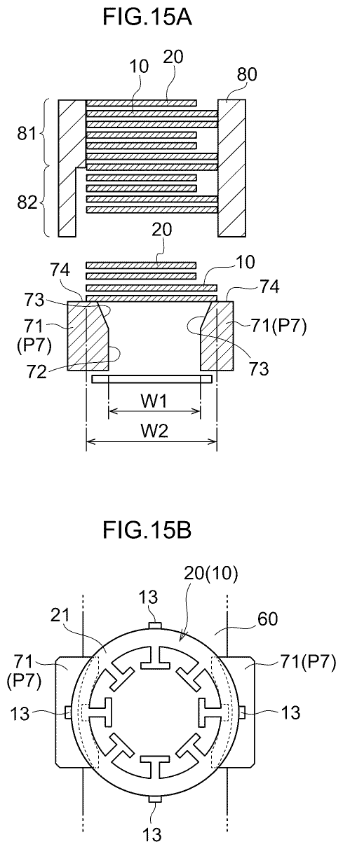

FIG. 15 are explanatory drawings showing a state in which the positioning mechanism is in a holding position in the laminated body manufacturing apparatus pertaining to the second embodiment of the disclosure, with FIG. 15A showing a state in which the positioning pieces of the manufacturing apparatus shown in FIG. 10 are in the holding position and with FIG. 15B showing the state of the conveyor and the positioning mechanism of the manufacturing apparatus shown in FIG. 10 in the state shown in FIG. 15A. The laminated body manufacturing apparatus 1A pertaining to the present embodiment may include a holding unit that is disposed between the conveyance direction downstream end portion of the second squeeze 80 and the conveyor 60 and is capable of holding the iron core members supplied onto the conveyor 60 before they are placed on the conveyor 60. Specifically, as shown in FIG. 15, the holding unit of the laminated body manufacturing apparatus 1A pertaining to the present embodiment can be configured by holding surfaces 74 formed on the conveyance direction upstream sides of the plurality of positioning pieces 71.

The holding surfaces 74 can be configured by flat surfaces formed on the upper portions of the plurality of positioning pieces 71. Additionally, by moving the plurality of positioning pieces 71 closer to the center of the conveyance path than they are in the positioning position P5, the holding surfaces 74 can be moved to a holding position P7 where they are capable of holding the iron core members conveyed out from the second squeeze 80 before the iron core members reach the conveyor 60. When the holding surfaces 74 are positioned in the holding position P7, as shown in FIG. 15A, the latching iron core members 10 and the non-latching iron core members 20 conveyed out from the second squeeze 80 are placed on the holding surfaces 74 before they reach the conveyor 60. Because of this, it becomes possible to freely operate the conveyor 60 during the series of processes for manufacturing the laminated body.

In association with this, the laminated body manufacturing method pertaining to the present embodiment may include a step of moving the positioning pieces 71 configuring the positioning mechanism 70 to the holding position P7 where the holding surfaces 74 are capable of holding the iron core members conveyed out from the second squeeze 80. A gap W1 between the positioning pieces 71 when they are in the holding position P7 may be smaller than a gap W2 between the positioning pieces when they are in the positioning position P5.

Although in the above embodiment an example was described where the holding unit is configured by parts of the positioning mechanism 70, the holding unit and the positioning mechanism 70 can also be configured by separate members. In that case, the holding unit can be configured by a unit having the same structure as the holding mechanism 55 of the laminated body manufacturing apparatus 1 pertaining to the first embodiment for example.

In the laminated body manufacturing apparatus and manufacturing method pertaining to each of the embodiments, an example was described where the latching iron core members 10 and the non-latching iron core members 20 configured by single electromagnetic steel sheets are used as the iron core members to manufacture the laminated body, but the shape of the iron core members is not limited to this. Thus, below, another example of the iron core members that can be used in the laminated body manufacturing apparatus and manufacturing method will be briefly described.

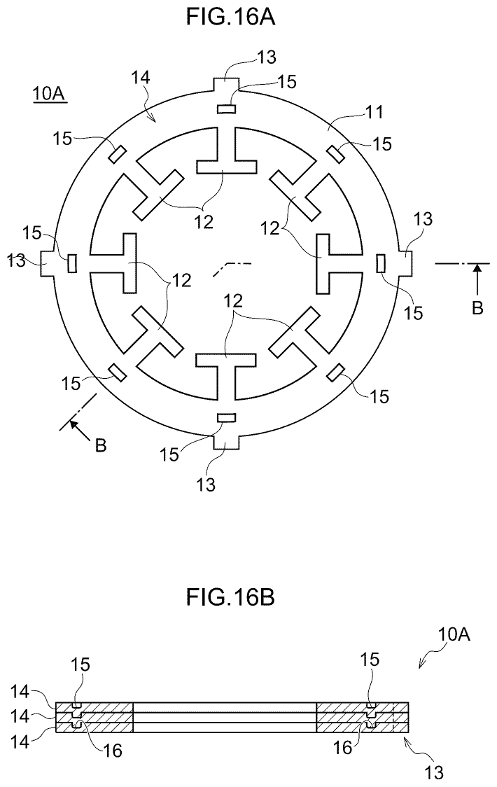

FIG. 16 are drawings showing another example of a latching iron core member supplied to the laminated body manufacturing apparatus pertaining to each of the embodiments of the disclosure, with FIG. 16A being a plan view and FIG. 16B being a sectional view taken along line B-B of FIG. 16A. As shown in FIG. 15, a latching iron core member 10A serving as another example of an iron core member is similar to the latching iron core member 10 in that it includes an annular yoke 11, teeth 12 provided on the inner periphery of the yoke 11, and latching pieces 13 that project in an outward direction from the outer peripheral surface of the yoke 11.

However, as shown in FIG. 16B, the latching iron core member 10A can be configured by a block body in which a plurality (e.g., three) of plate-shaped core pieces 14 are joined together. The core pieces 14 can be configured by thin electromagnetic steel sheets. It will be noted that the number of core pieces 14 configuring the block body is not particularly limited and can, for example, be adjusted as appropriate in the range of several to several dozens.

In addition, in order to join the plurality of core pieces 14 configuring the block body to each other, crimped portions 15 or holes 16 may be configured in appropriate places in the yokes 11 of the core pieces 14. When the core pieces 14 are laminated, the crimped portions 15 or holes 16 engage with each other, whereby the core pieces 14 can be joined. It will be noted that, among the plurality of core pieces 14 configuring the block body, it is preferred that the core piece 14 disposed on the bottom be provided with a hole portion 16 with no projection on the lower surface and that the other core pieces 14 be provided with crimped portions 15.

Furthermore, although in the present embodiment a case where the crimped portions 15 are employed as the structure for joining together the core pieces 14 was described as an example, other joining method can also be employed instead of this, such as, for example, a method where the core pieces are joined together by applying an adhesive to their joint surfaces.

Furthermore, although all the plurality of core pieces 14 configuring the latching iron core member 10 shown in FIG. 16 are provided with projections configuring the latching pieces 13, the projections need only be provided on at least the core piece 14 among the plurality of core pieces 14 that is positioned on the bottom of the latching iron core member 10. In other words, for the core pieces 14 that are disposed higher than the bottom in the latching iron core member 10 comprising the block body, core pieces with the same structure as core pieces 24 configuring a non-latching iron core member 20 described below for example, which are not provided with the projections configuring the latching pieces 13, may be used.

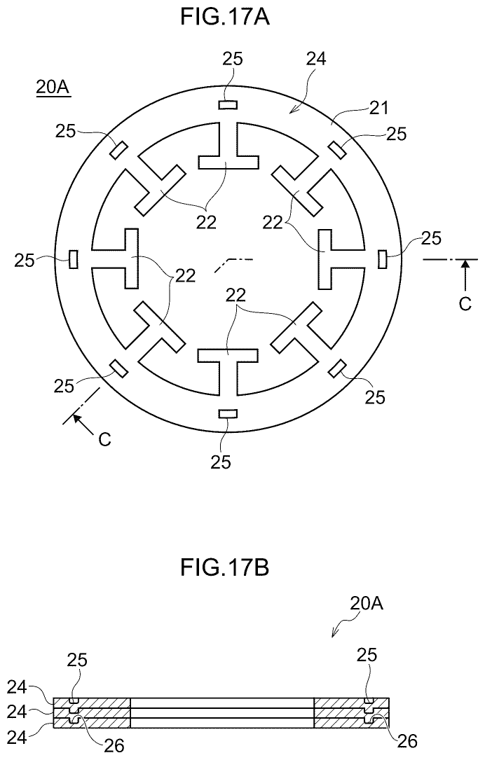

FIG. 17 are drawings showing another example of a non-latching iron core member supplied to the laminated body manufacturing apparatus pertaining to each of the embodiments of the disclosure, with FIG. 17A being a plan view and FIG. 17B being a sectional view taken along line C-C of FIG. 17A. As shown in FIG. 17A, a non-latching iron core member 20A serving as another example of an iron core member is similar to the non-latching iron core member 20 in that it includes an annular yoke 21 and teeth 22 that are provided on the inner peripheral surface of the yoke 21. The dimensions, arrangement, and number of the yoke 21 and the teeth 22 of the non-latching iron core member 20A may be set to match the dimensions, arrangement, and number of the yoke 11 and the teeth 12 of the latching iron core member 10A.

Furthermore, the non-latching iron core member 20A can also, like the latching iron core member 10A, be configured by a block body in which a plurality (e.g., three) of plate-shaped core pieces 24 having a relatively thin predetermined thickness are joined together.

Consequently, in these core pieces 24 also, crimped portions 25 or holes 26 for joining the core pieces 24 together may be formed. The core pieces 24 can, like the core pieces 14, be configured by thin electromagnetic steel sheets. The number of core pieces 24 configuring the non-latching iron core member 20A can be changed as appropriate in the range of several to several dozens, for example, regardless of the number of core pieces 14 of the latching iron core member 10.

In the laminated body manufacturing apparatus 1, 1A and manufacturing method pertaining to each of the embodiments, the latching iron core members 10 and the non-latching iron core members 20 serving as one example can be used in combination with the latching iron core members 10A and the non-latching iron core members 20A serving as another example. Specifically, at least some of the iron core members used in the laminated body manufacturing apparatus 1, 1A can be the latching iron core members 10A and the non-latching iron core members 20A.

The present disclosure is not limited to the embodiments described above and can be changed and implemented in a variety of ways without departing from the spirit of the disclosure. Additionally, all these are included in the technical thought of the disclosure.

All documents including publications, patent applications, and patents mentioned in this specification are incorporated herein by reference to the same extent as if each individual document were specifically and individually indicated to be incorporated by reference and were set forth in its entirety herein.

The use of nouns and similar referents used in the context of describing this disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including but not limited to”) unless otherwise noted. Recitation of numerical ranges herein is intended merely to serve as a shorthand method for referring individually to each separate value falling within the range, unless otherwise indicated herein, and each separate value is incorporated into the specification as if it were individually listed herein. All methods described herein can be performed in any suitable order unless otherwise indicated herein or otherwise clearly contradicted by context. The use of any and all examples or exemplary language (e.g., “such as”) herein is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of the disclosure are described herein, including the best modes known to the inventor for carrying out the disclosure. Variations of these preferred embodiments may become apparent to those of ordinary skill in the art upon reading the foregoing description. The inventor expects skilled artisans to apply such variations as appropriate, and the inventor intends for the disclosure to be practiced otherwise than as specifically described herein. Accordingly, the disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A laminated body manufacturing apparatus, comprising:
a squeeze capable of conveying, in a downward direction, a plurality of iron core members including latching iron core members that have latching pieces at a plurality of places on their outer peripheral surfaces and non-latching iron core members that do not have the latching pieces;
a supply mechanism that is positioned upstream of the squeeze in a conveyance direction of the iron core members and that is capable of selectively supplying the latching iron core members and the non-latching iron core members to the squeeze;
a conveyor that can receive the iron core members supplied from a conveyance direction downstream end portion of the squeeze and that is capable of conveying the iron core members in a direction intersecting with the conveyance direction; and
a positioning mechanism that is disposed between the conveyance direction downstream end portion of the squeeze and the conveyor in order to position the iron core members supplied onto the conveyor and that is movable in a direction toward and a direction away from side surfaces of the iron core members supplied from the conveyance direction downstream end portion of the squeeze,
wherein the squeeze includes a squeeze upstream portion that is positioned at a conveyance direction upstream side of the squeeze and that laterally supports a plurality of the latching iron core members and the non-latching iron core members passing through the squeeze, and a squeeze downstream portion that is positioned at a conveyance direction downstream side of the squeeze and that laterally supports the latching pieces of the latching iron core members passing through the squeeze.

2. The laminated body manufacturing apparatus of claim 1, wherein:
the positioning mechanism includes a plurality of positioning pieces disposed on an outer periphery of the iron core members placed on the conveyor, and
the plurality of positioning pieces include abutment surfaces, which oppose the side surfaces of the iron core members placed on the conveyor, and are movable between a positioning cancellation position at which the abutment surfaces are away from the side surfaces of the iron core members placed on the conveyor and a positioning position at which the abutment surfaces abut against the side surfaces of the iron core members placed on the conveyor or at which the abutment surfaces oppose the side surfaces of the iron core members via a smaller gap than they do at the positioning cancellation position.

3. The laminated body manufacturing apparatus of claim 2, wherein the abutment surfaces include tapered surfaces which, moving downstream in the conveyance direction, come nearer to the side surfaces of the iron core members placed on the conveyor.

4. The laminated body manufacturing apparatus of claim 2, wherein end portions of the abutment surfaces positioned downstream in the conveyance direction are positioned lower than a position of an upper surface of the iron core member that has been directly placed on the conveyor.

5. The laminated body manufacturing apparatus of claim 1, further comprising a holding unit that is disposed between the conveyance direction downstream end portion of the squeeze and the conveyor and that is capable of holding the iron core members supplied onto the conveyor before they are placed on the conveyor.

6. The laminated body manufacturing apparatus of claim 5, wherein:
the positioning mechanism includes a plurality of positioning pieces disposed on an outer periphery of the iron core members placed on the conveyor, and
the holding unit is configured by parts of the plurality of positioning pieces, and the plurality of positioning pieces are movable to a holding position at which holding surfaces provided at conveyance direction upstream sides thereof are capable of holding the iron core members supplied from the conveyance direction downstream end portion of the squeeze.

7. The laminated body manufacturing apparatus of claim 1, wherein at least some of the iron core members are configured by a block body in which a plurality of plate-shaped core pieces are joined to each other.

8. The laminated body manufacturing apparatus of claim 7, wherein crimped portions provided in the core pieces configuring the block body are used to join together the core pieces.

9. The laminated body manufacturing apparatus of claim 1, wherein:
a plurality of the iron core members are laminated to configure a block core, and
the block core configures a motor core on its own or as a result of more than one being laminated and is configured by one or a plurality of the latching iron core members positioned at a conveyance direction downstream side and one or a plurality of the non-latching iron core members positioned at a conveyance direction upstream side.

10. A laminated body manufacturing apparatus, comprising:
a supply mechanism capable of supplying, along a predetermined conveyance direction, a plurality of iron core members including latching iron core members that have latching pieces at a plurality of places on their outer peripheral surfaces or inner peripheral surfaces and non-latching iron core members that do not have the latching pieces;
a squeeze that is disposed downstream of the supply mechanism in the conveyance direction and that is capable of conveying along the conveyance direction, while laterally supporting, the iron core members supplied from the supply mechanism;
a conveyor that can receive the iron core members supplied from a conveyance direction downstream end portion of the squeeze and that is capable of conveying the iron core members in a direction intersecting with the conveyance direction;
a separation mechanism that is disposed between the squeeze and the conveyor in the conveyance direction and that controls supply of the iron core members to the conveyor; and
a positioning mechanism that is disposed between the separation mechanism and the conveyor in the conveyance direction in order to position the iron core members supplied onto the conveyor and that is movable in a direction toward and a direction away from side surfaces of the iron core members supplied from the conveyance direction downstream end portion of the squeeze,
wherein the separation mechanism includes latching portions capable of moving between a latching position at which they latch a plurality of the latching pieces of the latching iron core members supplied from the conveyance direction downstream end portion of the squeeze and a non-latching position at which they do not latch the latching pieces and an actuation device that moves the latching portions to the latching position and the non-latching position.

11. The laminated body manufacturing apparatus of claim 10, wherein the actuation device moves the latching portions from the latching position to the non-latching position and thereafter returns them to the latching position during periods when the non-latching iron core members are passing a position on a conveyance path of the iron core members that includes the latching position.

12. A laminated body manufacturing method, comprising:
supplying, to a squeeze, a plurality of iron core members including latching iron core members that have latching pieces at a plurality of places on their outer peripheral surfaces and non-latching iron core members that do not have the latching pieces, the squeeze including a squeeze upstream portion that is positioned at an upstream side of the squeeze in a conveyance direction of the iron core members and that laterally supports a plurality of the latching iron core members and the non-latching iron core members passing through the squeeze and a squeeze downstream portion that is positioned at a conveyance direction downstream side of the squeeze and that laterally supports the latching pieces of the latching iron core members passing through the squeeze;
moving, to a positioning position, a positioning mechanism disposed between a conveyance direction downstream end portion of the squeeze and the conveyor in order to position the iron core members supplied from a conveyance direction downstream end portion of the squeeze onto the conveyor;
supplying the iron core members from the conveyance direction downstream end portion of the squeeze onto the conveyor; and
when a predetermined number of the iron core members have been placed on the conveyor, moving the positioning mechanism to a positioning cancellation position and operating the conveyor to convey, in a direction intersecting with the conveyance direction, the predetermined number of the iron core members that have been placed on the conveyor.

13. The laminated body manufacturing method of claim 12, wherein at least some of the iron core members are configured by a block body in which a plurality of plate-shaped core pieces are joined to each other.

14. The laminated body manufacturing method of claim 12, further comprising moving the positioning mechanism to a holding position at which holding surfaces provided at conveyance direction upstream sides thereof are capable of holding the iron core members supplied from the conveyance direction downstream end portion of the squeeze.

15. A laminated body manufacturing method, comprising:
supplying, from a supply mechanism, a plurality of iron core members including latching iron core members that have latching pieces at a plurality of places on their outer peripheral surfaces or inner peripheral surfaces and non-latching iron core members that do not have the latching pieces;
using a squeeze to convey, while laterally supporting, the iron core members supplied from the supply mechanism, the squeeze being disposed downstream of the supply mechanism in a conveyance direction of the iron core members, and the iron core members laterally supported by the squeeze being conveyable along the conveyance direction through the squeeze;
using a separation mechanism to selectively support the iron core members supplied from a conveyance direction downstream end portion of the squeeze, the separation mechanism including latching portions capable of moving between a latching position at which they latch a plurality of the latching pieces of the latching iron core members supplied from the conveyance direction downstream end portion of the squeeze and a non-latching position at which they do not latch the latching pieces and an actuation device that moves the latching portions to the latching position and the non-latching position, the iron core members being supported as a result of the latching portions positioned at the latching position latching the latching pieces of the latching iron core members;
moving, to a positioning position, a positioning mechanism disposed between the separation mechanism and the conveyor in the conveyance direction in order to position the iron core members supplied onto the conveyor;
moving the latching portions from the latching position to the non-latching position in order to supply onto the conveyor a plurality of the iron core members supported by the separation mechanism;
returning the latching portions that were moved to the non-latching position to the latching position during periods when the non-latching iron core members are passing a position including the latching position on a conveyance path of the iron core members; and
when a predetermined number of the iron core members have been placed on the conveyor, moving the positioning mechanism to a positioning cancellation position and operating the conveyor to convey, in a direction intersecting with the conveyance direction, the predetermined number of the iron core members that have been placed on the conveyor.
